(19) United States
(12) Patent Application Publication
(10) Pub. No.: US 2022/0398613 A1
(43) Pub. Date: Dec. 15, 2022

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventor: Go TEJIMA, Toyota-shi (JP)

(73) Assignee: TOYOTA JIDOSHA KABUSHIKI KAISHA, Toyota-shi (JP)

(21) Appl. No.: 17/660,439

(22) Filed: Apr. 25, 2022

(30) Foreign Application Priority Data
Jun. 11, 2021 (JP) 2021-097934

(51) Int. Cl. G06Q 30/02; F17C 5/00; F17C 5/06

(52) U.S. Cl. CPC G06Q 30/0205; F17C 5/002; F17C 5/06; F17C 2221/012

(57) ABSTRACT

An information processing device has a prediction unit and a business hour decision unit. The prediction unit predicts a demand for hydrogen at a hydrogen station through the use of a demand prediction model that is a learned model generated in advance through mechanical learning and that receives at least a behavioral pattern of a client and outputs the predicted demand for hydrogen. The business hour decision unit decides business hours of the hydrogen station based on the predicted demand for hydrogen.

### CROSS-REFERENCE TO RELATED APPLICATION

This application claims priority to Japanese Patent Application No. 2021-097934 filed on Jun. 11, 2021, incorporated herein by reference in its entirety.

### BACKGROUND

### 1. Technical Field

The disclosure relates to an information processing device, an information processing method, and a storage medium, and more specifically, to an information processing device, an information processing method, and a storage medium that predict a demand for hydrogen at a hydrogen station.

### 2. Description of Related Art

Japanese Unexamined Patent Application Publication No. 2016-183768 (JP 2016-183768 A) discloses a method of controlling a reservation system for a hydrogen station that is designed to ensure smoothness in the process of filling with hydrogen fuel. The method according to JP 2016-183768 A makes it possible to input reservation information for reserving a date and hour for filling a user's vehicle with hydrogen fuel at a hydrogen station, and is designed to create a hydrogen filling reservation table where the input reservation information can be registered. Besides, the method according to JP 2016-183768 A is designed to calculate a required amount of hydrogen fuel on a noteworthy day after the lapse of days set in advance from a day read out through the use of the hydrogen filling reservation table where the reservation information from the user is registered.

### SUMMARY

With the art according to JP 2016-183768 A, it is impossible to grasp whether or not the user will visit the hydrogen station unless the user makes a reservation. Therefore, the demand for hydrogen cannot be predicted with accuracy. Besides, the business hours of the hydrogen station are usually fixed, and hence may not match the demand for hydrogen. Accordingly, it may be difficult to maintain a balance between the demand for hydrogen and the supply of hydrogen at the hydrogen station.

The disclosure provides an information processing device, an information processing method, and a storage medium that can maintain a balance between the demand for hydrogen and the supply of hydrogen at a hydrogen station.

An information processing device according to the disclosure has a prediction unit that predicts a demand for hydrogen at a hydrogen station through the use of a demand prediction model that is a learned model generated in advance through mechanical learning and that receives at least a behavioral pattern of a client and outputs the predicted demand for hydrogen, and a decision unit that decides business hours of the hydrogen station based on the predicted demand for hydrogen.

Besides, an information processing method according to the disclosure is designed to predict a demand for hydrogen at a hydrogen station through the use of a demand prediction model that is a learned model generated in advance through mechanical learning and that receives at least a behavioral pattern of a client and outputs the predicted demand for hydrogen, and decide business hours of the hydrogen station based on the predicted demand for hydrogen.

Besides, a storage medium according to the disclosure stores a program that causes a computer to execute a step of predicting a demand for hydrogen at a hydrogen station through the use of a demand prediction model that is a learned model generated in advance through mechanical learning and that receives at least a behavioral pattern of a client and outputs the predicted demand for hydrogen, and a step of deciding business hours of the hydrogen station based on the predicted demand for hydrogen.

Owing to the foregoing configuration of the disclosure, the business hours matching the demand for hydrogen can be decided at the hydrogen station. Thus, the possibility of hydrogen being available for supply in accordance with the demand for hydrogen at the hydrogen station is enhanced. Accordingly, the disclosure can maintain a balance between the demand for hydrogen and the supply of hydrogen at the hydrogen station.

Besides, the decision unit preferably changes a business opening time to a time earlier than a usual business opening time of the hydrogen station when the predicted demand in a predetermined period including the usual business opening time is higher than a predetermined value.

Owing to this configuration of the disclosure, the business opening time of the hydrogen station can be changed in accordance with the demand for hydrogen.

Besides, the decision unit preferably changes a business closing time to a time later than a usual business closing time of the hydrogen station when the predicted demand in a predetermined period including the usual business closing time is higher than a predetermined value.

Owing to this configuration of the disclosure, the business closing time of the hydrogen station can be changed in accordance with the demand for hydrogen.

Besides, the decision unit preferably decides business hours after a time determined in advance.

Owing to this configuration of the disclosure, it is much easier to adjust the dates and hours when an employee of the hydrogen station is scheduled to be on duty. Therefore, the convenience for the employee can be enhanced.

Besides, the decision unit preferably decides business hours of the hydrogen station, based on dates and hours when an employee of the hydrogen station is ready to be on duty.

Owing to this configuration of the disclosure, the business hours of the hydrogen station are decided in accordance with the dates and hours when the employee is ready to be on duty. Therefore, the convenience for the employee can be enhanced.

Besides, preferably, the information processing device further has a notification unit that notifies the client of the decided business hours.

Owing to this configuration of the disclosure, the convenience for the client can be enhanced.

Besides, the notification unit preferably notifies each client of business hours at a required timing.

Owing to this configuration of the disclosure, the convenience for each client can be further enhanced.

The disclosure can provide an information processing device, an information processing method, and a storage medium that can maintain a balance between the demand for hydrogen and the supply of hydrogen at a hydrogen station.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view showing an information processing system according to the first embodiment;

FIG. 2 is a view showing the hardware configuration of an information processing device according to the first embodiment;

FIG. 3 is a block diagram showing the configuration of the information processing device according to the first embodiment;

FIG. 4 is a view exemplifying input data that are input to a demand prediction model according to the first embodiment;

FIG. 5 is a view exemplifying feature amounts in the input data according to the first embodiment;

FIG. 6 is a view exemplifying a client behavioral pattern according to the first embodiment;

FIG. 7 is a view exemplifying another client behavioral pattern according to the first embodiment;

FIG. 8 is a view exemplifying still another client behavioral pattern according to the first embodiment;

FIG. 9 is a view exemplifying still another client behavioral pattern according to the first embodiment;

FIG. 10 is a view exemplifying output data that are output from the demand prediction model according to the first embodiment;

FIG. 11 is a view exemplifying a prediction of demand obtained by a demand prediction unit according to the first embodiment;

FIG. 12 is a flowchart showing an information processing method that is carried out by the information processing device according to the first embodiment;

FIG. 13 is another flowchart showing the information processing method that is carried out by the information processing device according to the first embodiment;

FIG. 14 is a block diagram showing the configuration of an information processing device according to the second embodiment;

FIG. 15 is a view exemplifying business hours of a hydrogen station;

FIG. 16 is a view for illustrating a method of deciding the business hours of the hydrogen station in the second embodiment;

FIG. 17 is a view for illustrating another method of deciding the business hours of the hydrogen station in the second embodiment;

FIG. 18 is a view exemplifying notification of business hours according to the second embodiment;

FIG. 19 is a flowchart showing an information processing method that is carried out by the information processing device according to the second embodiment;

FIG. 20 is a block diagram showing the configuration of an information processing device according to the third embodiment;

FIG. 21 is a view exemplifying employee information according to the third embodiment; and

FIG. 22 is a flowchart showing an information processing method that is carried out by the information processing device according to the third embodiment.

### DETAILED DESCRIPTION OF EMBODIMENTS

### First Embodiment

The embodiments of the disclosure will be described hereinafter with reference to the drawings. For the sake of clear explanation, the following description and drawings are omitted and simplified as appropriate. Besides, in the respective drawings, like elements are denoted by like reference symbols, and redundant description is omitted as needed.

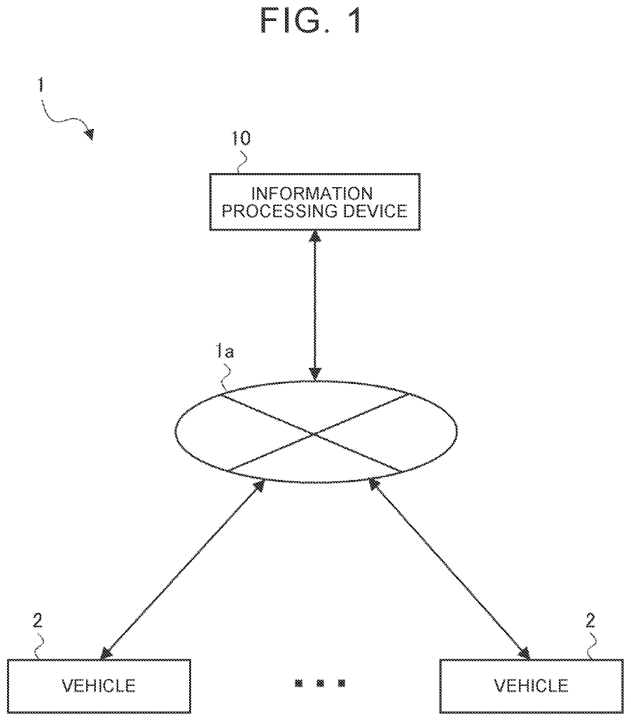

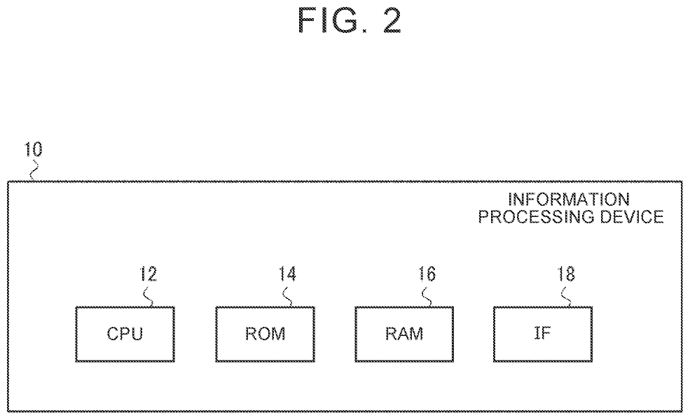

FIG. 1 is a view showing an information processing system 1 according to the first embodiment. The information processing system 1 has a plurality of vehicles 2 and an information processing device 10. Each of the vehicles 2 is a vehicle that uses hydrogen as fuel (e.g., a fuel cell electric vehicle). The information processing device 10 is, for example, a computer such as a server. The information processing device 10 can be connected to the vehicles 2 in such a manner as to enable communication, via a network 1a such as radio. Incidentally, each of the vehicles 2 may have a hardware configuration of the information processing device 10 that will be described later using FIG. 2.

The information processing device 10 predicts a demand for hydrogen at a hydrogen station that supplies hydrogen to the vehicles 2. In concrete terms, the information processing device 10 predicts a demand for hydrogen through an algorithm of mechanical learning such as deep learning, a neural network, or a recurrent neural network. The information processing device 10 can be realized by a single computer or a plurality of computers. Besides, the information processing device 10 may be realized by a cloud system. Accordingly, the information processing device 10 may not necessarily be physically realized by a single device.

FIG. 2 is a view showing the hardware configuration of the information processing device 10 according to the first embodiment. The information processing device 10 has a central processing unit (CPU) 12, a read only memory (ROM) 14, a random access memory (RAM) 16, and an interface (IF) unit 18, as a main hardware configuration. The CPU 12, the ROM 14, the RAM 16, and the interface unit 18 are connected to one another via a data bus or the like.

The CPU 12 functions as an arithmetic device (a processing device or a processor) that performs a control process, an arithmetic process, or the like. Incidentally, the arithmetic device may be realized by a dedicated device for mechanical learning such as a neural network processing unit (NPU) or a graphics processing unit (GPU). The ROM 14 functions as a storage for storing a control program, an arithmetic program, and the like that are executed by the CPU 12 (the arithmetic device). The RAM 16 functions as a memory for temporarily storing processed data and the like. The interface unit 18 functions as a communication device to which signals are input and from which signals are output via a wire or through radio. Besides, the interface unit 18 functions as a user interface that accepts an operation of inputting data by a user and that performs a process for displaying information to the user. The interface unit 18 may display a result of prediction of the demand.

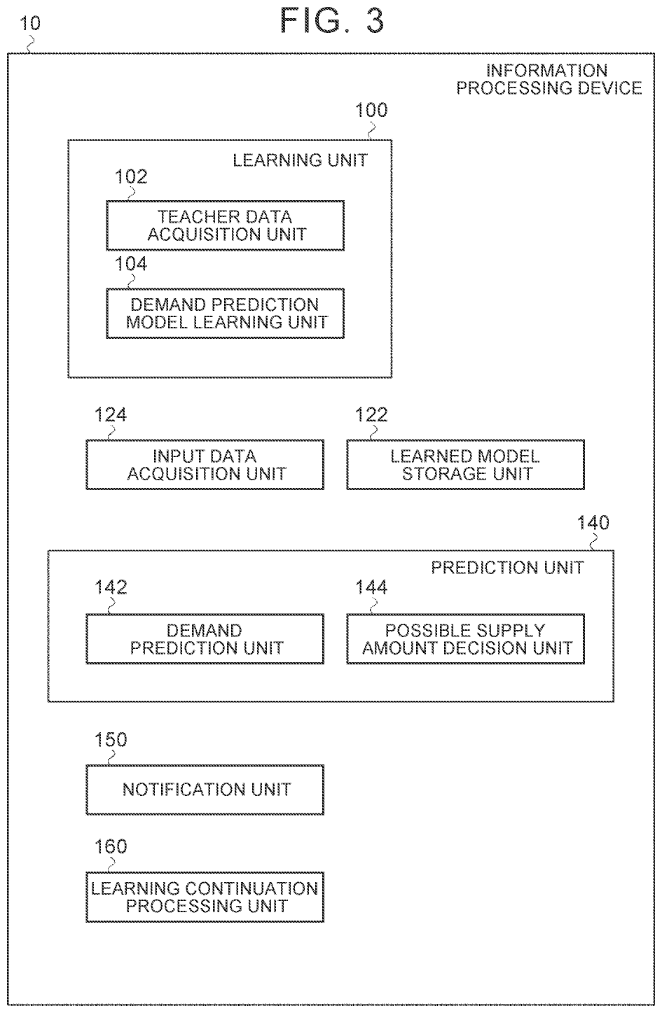

FIG. 3 is a block diagram showing the configuration of the information processing device 10 according to the first embodiment. The information processing device 10 according to the first embodiment has a learning unit 100, a learned model storage unit 122, an input data acquisition unit 124 (an acquisition unit), a prediction unit 140, a notification unit 150, and a learning continuation processing unit 160. The learning unit 100 has a teacher data acquisition unit 102 and a demand prediction model learning unit 104. The prediction unit 140 has a demand prediction unit 142 and a possible supply amount decision unit 144.

These components can be realized through, for example, execution of the program stored in the ROM 14 (the storage device) by the CPU 12 (the arithmetic device). Besides, each of the components may be realized such that a required program is recorded in any non-volatile recording medium and installed as needed. Incidentally, each of the components may not necessarily be realized by a piece of software as described above, but may be realized by some piece of hardware such as a circuit element. Besides, one or more of the components may be realized by one or more physically distinct pieces of hardware respectively. For example, the learning unit 100 may be realized by a piece of hardware different from the other components. These also hold true for the other embodiments that will be described later.

The learning unit 100 learns a demand prediction model for predicting a demand for hydrogen at a hydrogen station, through the aforementioned algorithm of mechanical learning. In other words, the learning unit 100 mechanically learns the demand prediction model. The learning unit 100 carries out mechanical learning in such a manner as to predict a demand for hydrogen through the use of at least a behavioral pattern of a client. Accordingly, the demand prediction model receives input data including at least client behavioral pattern information indicating the behavioral pattern of the client, and outputs a demand (a predicted volume of demand for hydrogen (a predicted volume of demand)) at each of hydrogen stations. The predicted volume of demand indicates a volume of demand for hydrogen after a period determined in advance (e.g., after one day, after two days, after one week, or after one month).

The teacher data acquisition unit 102 acquires teacher data as pairs of input data and right answer data. The input data include client behavioral pattern information and regional information. It should be noted herein that the input data are time-series data including feature amounts that change in value with the lapse of time.

The client behavioral pattern information indicates behavioral patterns of a plurality of clients. Accordingly, the client behavioral pattern information can be generated as to each of the clients. The client behavioral pattern information can be acquired via the network 1a from, for example, the vehicle 2 owned by each of the clients. The client behavioral pattern information indicates, for example, a timing when each of the clients fills the vehicle 2 with hydrogen (a filling frequency), one or more hydrogen stations visited by each of the clients, and a filling amount in filling the vehicle 2 with hydrogen. The details will be described later.

The regional information is information different from the behavioral patterns of the clients, and indicates various pieces of information in regions. The regional information indicates, for example, the weather, information on hydrogen stations in a corresponding region, information on events in the corresponding region, and the like. The details will be described later.

The right answer data correspond to output data at an operational stage (an inference stage or a prediction stage). It should be noted herein that the output data indicate a volume of demand for hydrogen after a period determined in advance at each of the hydrogen stations, as described above. Accordingly, the right answer data correspond to an actual volume of demand for hydrogen at a certain timing, at each of the hydrogen stations.

The demand prediction model learning unit 104 performs a learning process for learning the demand prediction model through the use of the acquired teacher data. The demand prediction model can be realized by, for example, a mechanical learning algorithm such as deep learning, a neutral network, or a recurrent neural network. The demand prediction model learning unit 104 receives input data, and learns the demand prediction model such that the difference between a predicted value and the right answer data becomes small. The demand prediction model learning unit 104 carries out an adjustment and the like of parameters serving as weights, such that the difference between the predicted value and the right answer data becomes small. The demand prediction model learning unit 104 may generate a demand prediction model, using teacher data during a certain period (e.g., several months) as learning data. Moreover, the demand prediction model learning unit 104 may adjust the parameters (weights and the like) of the demand prediction model, using teacher data during a predetermined period (e.g., several weeks) after the period as evaluation data. Besides, the demand prediction model learning unit 104 may extract important feature amounts from the input data, through an autoencoder.

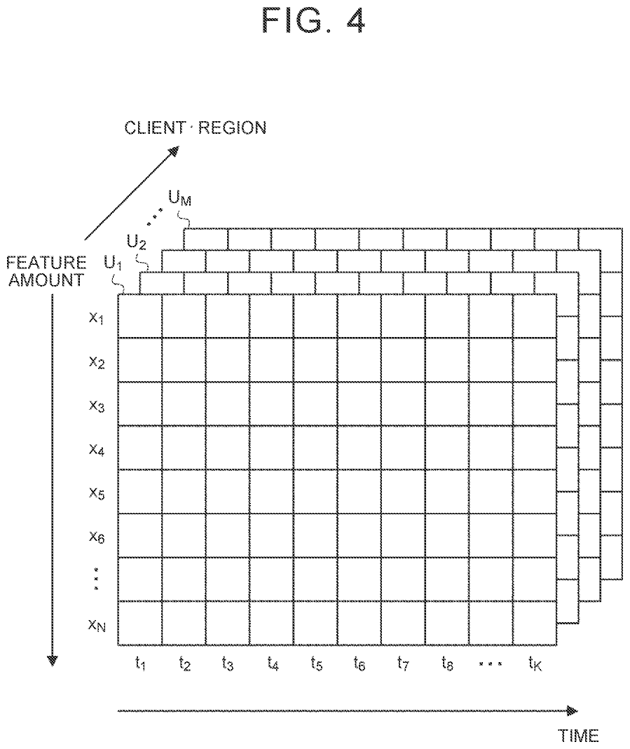

FIG. 4 is a view exemplifying input data that are input to the demand prediction model according to the first embodiment. As exemplified in FIG. 4, the input data are time-series data with a plurality of feature amounts. In the example of FIG. 4, the input data are presented with the axis of abscissa representing time and the axis of ordinate representing time-series feature amounts. That is, respective feature amounts x₁, x₂, x₃, . . . , x_{N} are time-series data. N is the number of feature amounts. The feature amounts may be sampled at intervals of, for example, a predetermined period Δt. In this case, Δt represents a time interval among t₁, t₂, t₃, . . . , tₖ along the axis of abscissa of FIG. 4. Besides, Δt may be, for example, 30 minutes, one hour, six hours, or one day (24 hours). This sampling period Δt can be set as appropriate, depending on the time-series degree of fineness of desired demand prediction. For example, the sampling period Δt in the case where a prediction of demand is desired to be obtained every several hours may be shorter than the sampling period Δt in the case where a prediction of demand is desired to be obtained every several days.

Besides, the input data can be generated for each of the clients and for each of the regions. For example, input data (client behavioral pattern information) U₁, U₂, and U₃ on clients #1, #2, and #3 are generated respectively. Besides, input data (regional information) Uₘ₊₁, Uₘ₊₂, and Uₘ₊₃ on regions #1, #2, and #3 are generated respectively. Pairs of these input data U₁ to U_{M} are input to the demand prediction model as the input data.

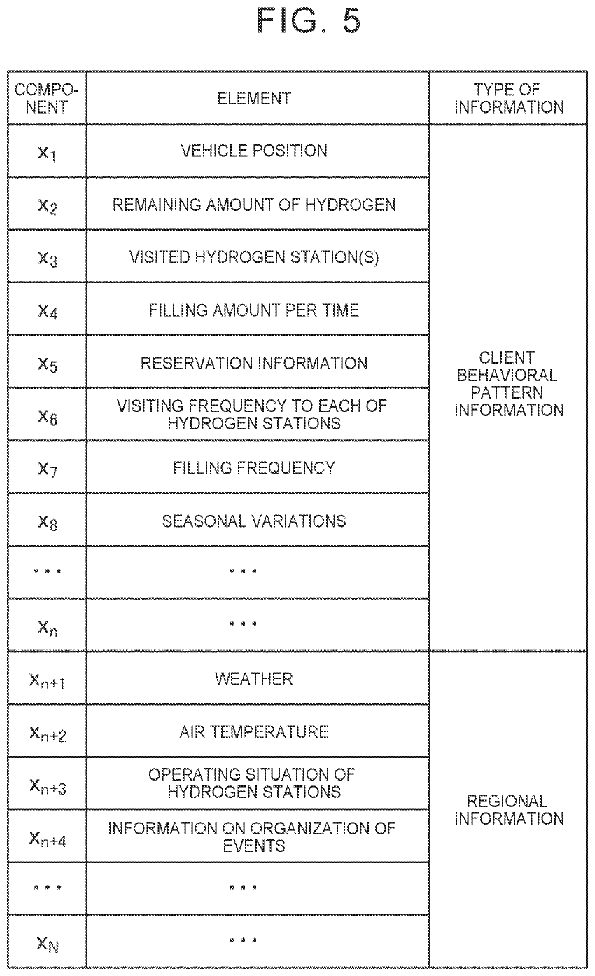

FIG. 5 is a view exemplifying feature amounts in the input data according to the first embodiment. Incidentally, the feature amounts exemplified in FIG. 5 are nothing more than an example, and other various feature amounts are conceivable. It should be noted herein that components x₁ to xₙ indicate feature amounts in the client behavioral pattern information respectively in FIG. 5. Besides, components xₙ₊₁ to x_{N} indicate feature amounts in the regional information respectively. Incidentally, the values of xₙ₊₁ to x_{N} may be 0 in the client behavioral pattern information. By the same token, the values of x₁ to xₙ may be 0 in the regional information.

As for the feature amounts included in the client behavioral pattern information, the component x₁ indicates a position of the vehicle 2 (a vehicle position) of a corresponding client at a corresponding time (a sampling time) in the example shown in FIG. 5. Besides, the component x₂ indicates a remaining amount of hydrogen in the vehicle 2 of the corresponding client at the corresponding time (the sampling time). The remaining amount of hydrogen may be a filling rate (state of charge: SOC).

Besides, the component x₃ indicates one or more hydrogen stations visited by the corresponding client to fill the vehicle 2 with hydrogen at the corresponding time (the sampling time). Incidentally, the component value of x₃ is determined in advance for each of the hydrogen stations, as in the case of, for example, “a hydrogen station A: x₃=1” and “a hydrogen station B: x₃=2”. Incidentally, if there is no hydrogen station visited by the client at the corresponding time (the sampling time), the component value of x₃ may be 0.

The component x₄ indicates a filling amount of hydrogen with which the vehicle 2 of the corresponding client is filled. Incidentally, the filling amount may be an increase in filling rate in filling the vehicle 2 with hydrogen. Incidentally, if the client does not fill the vehicle 2 with hydrogen at the corresponding time (the sampling time), the component value of x₄ may be 0. Besides, the component x₅ indicates reservation information on the corresponding client. The reservation information indicates whether or not the client has reserved the filling of the vehicle 2 with hydrogen in advance on a visit to a hydrogen station at the corresponding time (the sampling time). Incidentally, the component value of x₅ is determined in advance depending on whether or not a reservation has been made as in the case of, for example, “x₅=1 if a reservation has been made” and “x₅=0 if no reservation has been made”.

Besides, the component x₆ indicates a visiting frequency of the corresponding client to each of the hydrogen stations. Besides, the component x₇ indicates a filling frequency with which the corresponding client fills the vehicle 2 with hydrogen. Besides, the component x₅ indicates seasonal variations in the behavioral pattern of the corresponding client. Incidentally, as will be described later, x₆ to x₈ may not be time-series data, but can be derived from the client behavioral pattern information. Accordingly, x₆ to x₈ may not be included as the feature amounts.

As for the feature amounts included in the regional information, the component xₙ₊₁ indicates the weather in a corresponding region at the corresponding time (the sampling time) in the example shown in FIG. 5. Incidentally, the component value of xₙ₊₁ is determined in advance for each of weather types (sunny weather, rainy weather, and the like) as in the case of, for example, “sunny weather: xₙ₊₁=1” and “rainy weather: xₙ₊₁=2”. Besides, the component xₙ₊₂ indicates an air temperature in the corresponding region at the corresponding time (the sampling time). Besides, the component xₙ₊₃ indicates an operating situation of a hydrogen station provided in the corresponding region at the corresponding time (the sampling time). The operating situation indicates whether or not the corresponding hydrogen station is in operation, for example, on each day of the week and during each period of time. Besides, the component xₙ₊₄ indicates event organization information in the corresponding region. The event organization information may indicate the types of events to be organized at the corresponding time (the sampling time) and the scales (capacities or the like) of the events.

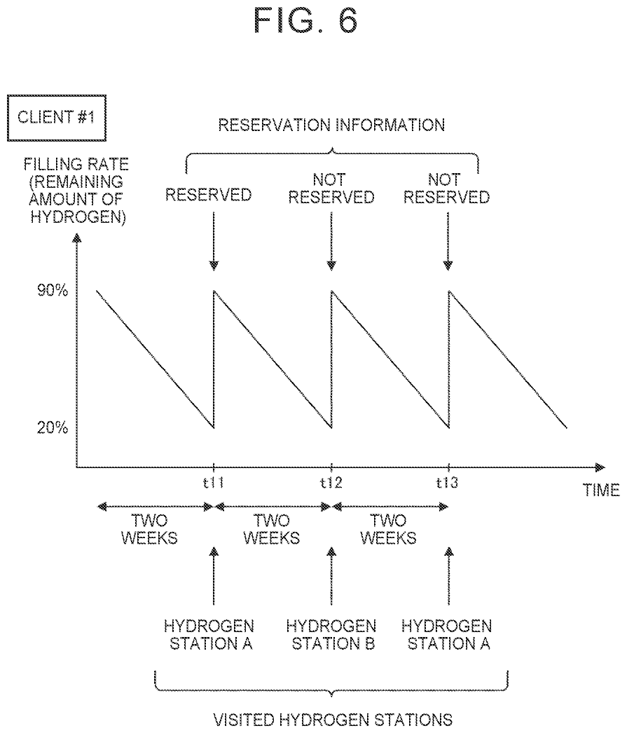

Each of FIGS. 6 to 9 is a view exemplifying the client behavioral pattern according to the first embodiment. The client behavioral pattern exemplified in each of FIGS. 6 to 9 is presented as a graph with the axis of abscissa representing time and the axis of ordinate representing the filling rate of hydrogen (the remaining amount of hydrogen) in the vehicle 2 of the corresponding client. Accordingly, the client behavioral pattern is time-series data. Incidentally, each of FIGS. 6 to 9 shows time-dependent changes in the filling rate of hydrogen. Accordingly, the time-dependent changes in filling rate in each of FIGS. 6 to 9 correspond to “the remaining amount of hydrogen” as the feature amount exemplified in FIG. 5. Incidentally, the client behavioral pattern may indicate time-dependent changes in position of the corresponding vehicle 2. In this case, the time-dependent changes in position of the vehicle 2 correspond to “the vehicle position” as the feature amount exemplified in FIG. 5.

FIG. 6 exemplifies a client behavioral pattern of the client #1. In the client behavioral pattern exemplified in FIG. 6, the filling rate of hydrogen falls to 20% after the lapse of about two weeks from the time when the filling rate is 90%, in the vehicle 2 of the client #1. Then, when the filling rate falls to 20% for the first time (at time t11), the client #1 visits the hydrogen station A to fill the vehicle 2 with hydrogen from 20% to 90%, that is, with hydrogen corresponding to the filling rate of 70%. At this time, the client #1 visits the hydrogen station A to make a reservation for the filling of the vehicle 2 with hydrogen.

Besides, when the filling rate falls to 20% for the second time (at time t12), the client #1 visits the hydrogen station B to fill the vehicle 2 with hydrogen from 20% to 90%, that is, with hydrogen corresponding to the filling rate of 70%. At this time, the client #1 has not visited the hydrogen station B to make a reservation for the filling of the vehicle 2 with hydrogen. Besides, when the filling rate falls to 20% for the third time (at time t13), the client #1 visits the hydrogen station A to fill the vehicle 2 with hydrogen from 20% to 90%, that is, with hydrogen corresponding to the filling rate of 70%. At this time, the client #1 has not visited the hydrogen station A to make a reservation for the filling of the vehicle 2 with hydrogen.

It should be noted herein that the respective visits to the hydrogen station A, the hydrogen station B, and the hydrogen station A at time t11, time t12, and time t13 respectively in the client behavioral pattern exemplified in FIG. 6 correspond to “the visited hydrogen station(s)” as the feature amount exemplified in FIG. 5. Besides, the filling of the vehicle 2 with hydrogen corresponding to the filling rate of 70% at time t11, time t12, and t13 corresponds to “the filling amount per time” as the feature amount exemplified in FIG. 5. Besides, the respective statuses of “reserved”, “not reserved”, and “reserved” at time t11, time t12, and time t13 correspond to “the reservation information” as the feature amount exemplified in FIG. 5.

Besides, the respective visits to the hydrogen station A by the client #1 at time t11 and time t13 and the visit to the hydrogen station B by the client #1 at time t12 correspond to “the visiting frequency to each of the hydrogen stations” as the feature amount exemplified in FIG. 5. Besides, the filling of the vehicle 2 with hydrogen every two weeks corresponds to “the filling frequency” as the feature amount exemplified in FIG. 5.

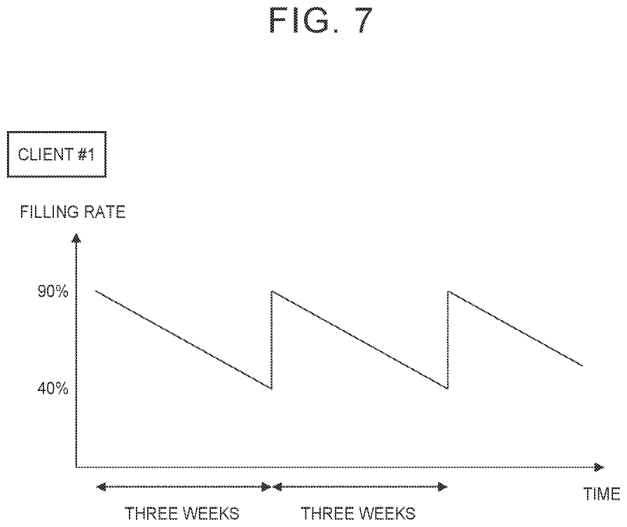

FIG. 7 exemplifies a client behavioral pattern of the client #1 in a season different from that in FIG. 6. FIG. 6 corresponds to the client behavioral pattern in summer, whereas FIG. 7 corresponds to the client behavioral pattern in winter. The client #1 fills the vehicle 2 with hydrogen when the filling rate falls to 20% in summer, whereas the client #1 fills the vehicle 2 with hydrogen when the filling rate falls to 40% in winter. That is, the client #1 fills the vehicle 2 with hydrogen in winter when the filling rate falls by a smaller value than in summer. On the other hand, the client #1 fills the vehicle 2 with hydrogen every two weeks in summer, whereas the client #1 fills the vehicle 2 with hydrogen every three weeks in winter. That is, the filling frequency of the client #1 is lower in winter than in summer. The difference in behavioral pattern depending on the season as described hitherto corresponds to “the seasonal variations” as the feature amount exemplified in FIG. 5.

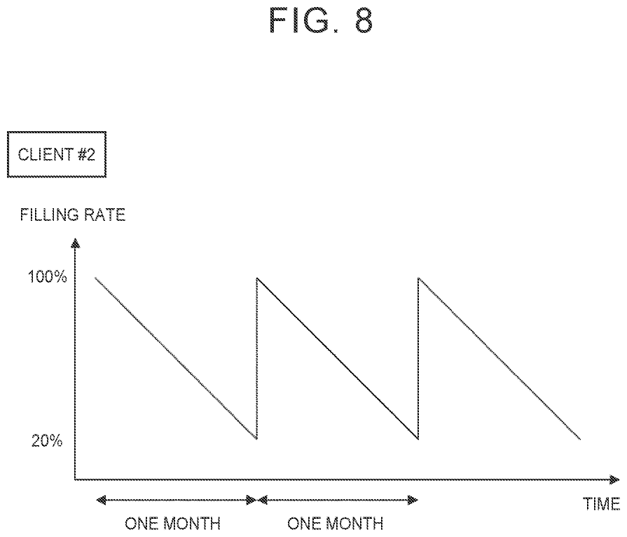

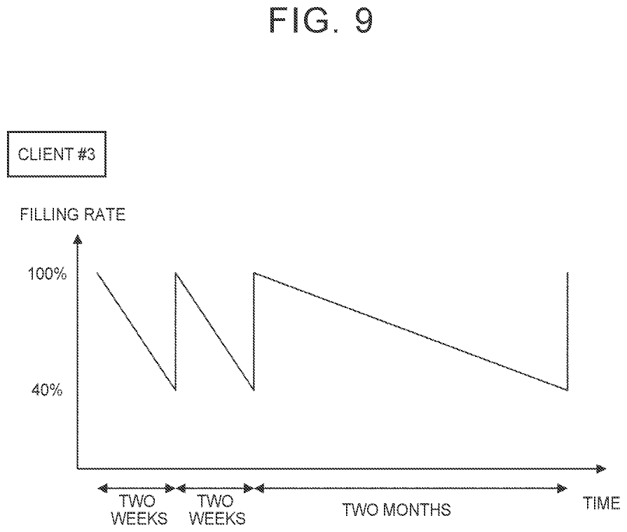

FIG. 8 exemplifies a client behavioral pattern of the client #2. Besides, FIG. 9 exemplifies a client behavioral pattern of the client #3. Incidentally, the same time axis is used in FIG. 8 and FIG. 9. As exemplified in FIG. 8, the client #2 fills the vehicle 2 with hydrogen every month. Besides, the client #2 fills the vehicle 2 with hydrogen when the filling rate falls to 20%. On the other hand, as exemplified in FIG. 9, the client #3 fills the vehicle 2 with hydrogen every two weeks, but may not fill the vehicle 2 with hydrogen for two months. Besides, the client #3 fills the vehicle 2 with hydrogen when the filling rate falls to 40%. That is, the filling frequency of the client #3 is usually higher than the filling frequency of the client #2. Besides, the client #3 fills the vehicle 2 with hydrogen when the filling rate falls by a smaller value than the client #2 does. Besides, the client #2 fills the vehicle 2 with hydrogen substantially on the same cycle, whereas the client 3 consumes a small amount of hydrogen during a certain period and hence does not fill the vehicle 2 with hydrogen on a constant cycle. As described hitherto, the behavioral pattern can differ depending on the client.

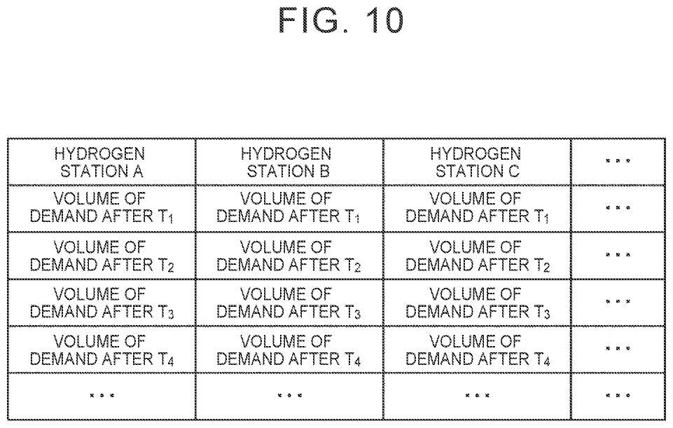

FIG. 10 is a view exemplifying output data that are output from the demand prediction model according to the first embodiment. As exemplified in FIG. 10, a predicted volume of demand for hydrogen after a predetermined period at each of the hydrogen stations is output from the demand prediction model. In the example of FIG. 10, a volume of demand for hydrogen after a period T₁, a volume of demand for hydrogen after a period T₂, a volume of demand for hydrogen after a period T₃, and a volume of demand for hydrogen after a period T₄ are output from the demand prediction model as to the hydrogen station A. The same holds true for the hydrogen station B and a hydrogen station C.

It should be noted herein that the right answer data can correspond to the output data exemplified in FIG. 10 in the teacher data used at a learning stage. Accordingly, the right answer data may be, for example, the actual volume of demand for hydrogen after the period T₁, the period T₂, the period T₃, and the period T₄ from a last time point (corresponding to tₖ in FIG. 4) on a timeline of the input client behavioral pattern information, as to the hydrogen station A.

Incidentally, at the learning stage, information prior to a prediction target timing for the demand for hydrogen (a time point after a predetermined period such as the period T₁) can be used as the input data, as to the client behavioral pattern information. Incidentally, at the operational stage, information in the past on the timeline can be used as the input data, as to the client behavioral pattern information. This is because it is substantially difficult to acquire the client behavioral pattern information in the future at the operational stage. Incidentally, in the client behavioral pattern information, information to the prediction target timing (information in the future) may be used as the input data when there is a reservation at the prediction target timing, as to the reservation information.

On the other hand, information to the prediction target timing may also be used as the input data, as to the regional information. That is, at the operational stage, information in the future can also be used as the input data, as to the regional information. It should be noted herein that “the weather” and “the air temperature” can be acquired from the weather forecast in the example of FIG. 5. Besides, “the operating situation of the hydrogen stations” can be acquired from an operation schedule of the hydrogen stations. Besides, “the event organization information” can be acquired from a schedule for organizing events.

In learning a prediction of demand after the period T₁ at a time T₀, the demand prediction model learning unit 104 may receive the input data during a period ΔT in the past from T₀, use an actual volume of demand for hydrogen after the period T₁ from the time T₀ as the right answer data, and learn the demand prediction model. Incidentally, ΔT corresponds to a period from t₁ to tₖ on the time axis of FIG. 4. It should be noted herein that ΔT>Δt. For example, when the sampling period is Δt=30 minutes, the input data during the past six hours from T₀ may be input to the demand prediction model on the assumption that ΔT=six hours. Besides, when the sampling period is Δt=24 hours, the input data during the past one month from T₀ may be input to the demand prediction model on the assumption that ΔT=one month. Alternatively, when the sampling period is Δt=24 hours, the input data during the past one year from T₀ may be input to the demand prediction model on the assumption that ΔT=one year.

Upon ending the learning of the demand prediction model, the demand prediction model learning unit 104 outputs the learned demand prediction model to the learned model storage unit 122. Thus, the learned model storage unit 122 stores the demand prediction model that is a learned model generated in advance through mechanical learning. Moreover, the demand prediction model that is the learned model receives the input data that are time-series data including the feature amounts as exemplified in FIG. 4 and FIG. 5, and outputs the predicted demand for hydrogen at each of the hydrogen stations as exemplified in FIG. 10.

Besides, the learning unit 100 may continue to learn the demand prediction model in accordance with a difference between a demand predicted by the prediction unit 140 that will be described later and an actual demand. The details will be described later.

The input data acquisition unit 124 acquires the aforementioned input data at the operational stage. It should be noted herein that the input data acquisition unit 124 acquires at least a client behavioral pattern (the client behavioral pattern information) as the input data. The input data acquisition unit 124 acquires the client behavioral pattern information as the input data from each of the vehicles 2, via the network 1a through the use of the interface unit 18. Besides, the input data acquisition unit 124 acquires the regional information as the input data. Besides, the input data acquisition unit 124 acquires the client behavioral pattern information as the time-series data, for example, during a predetermined period in the past from the present time point. Besides, the input data acquisition unit 124 acquires the regional information as the time-series data, for example, from a time point earlier than the present by a predetermined period to a future time point when the data can be acquired.

The prediction unit 140 predicts a demand for hydrogen at at least one of the hydrogen stations, through the use of the demand prediction model stored in the learned model storage unit 122. That is, the prediction unit 140 predicts a demand for hydrogen at at least one of the hydrogen stations, through the use of the demand prediction model that receives at least the client behavioral pattern information and that outputs the predicted demand for hydrogen.

The demand prediction unit 142 inputs the input data acquired by the input data acquisition unit 124 to the demand prediction model stored in the learned model storage unit 122. Thus, the demand prediction model outputs a predicted volume of demand for hydrogen at each of the hydrogen stations as exemplified in FIG. 10. Thus, the demand prediction unit 142 predicts a volume of demand for hydrogen at each of the hydrogen stations.

As described hitherto, the demand prediction unit 142 (the prediction unit 140) is configured to predict a demand for hydrogen at at least one of the hydrogen stations, through the use of the demand prediction model that receives at least the client behavioral pattern information and that outputs the predicted demand for hydrogen. Thus, the information processing device 10 according to the first embodiment can accurately predict the demand for hydrogen at each of the hydrogen stations. That is, the information processing device 10 is configured to predict the demand for hydrogen through the use of the behavioral pattern of each of the clients, and hence can predict the demand for hydrogen even when the client does not make a reservation for a visit to a hydrogen station with a view to filling the vehicle with hydrogen. In consequence, the information processing device 10 according to the first embodiment can accurately predict the demand for hydrogen.

Besides, it can be concluded from the feature amounts exemplified in FIG. 5, namely, “the remaining amount of hydrogen”, “the visited hydrogen station(s)”, and “the filling amount per time” that the client behavioral pattern information as the time-series data indicates the timing when the client fills the vehicle with hydrogen. That is, the timing when the component value of “the remaining amount of hydrogen” as the feature amount rises and the component values of “the visited hydrogen station(s)” and “the filling amount per time” as the feature amounts change corresponds to the timing when the client fills the vehicle with hydrogen. Accordingly, the demand prediction unit 142 predicts a demand for hydrogen through the use of the timing when the client fills the vehicle with hydrogen, which is indicated by the client behavioral pattern information. The demand prediction unit 142 (the prediction unit 140) predicts the demand for hydrogen as described above, and hence can enhance the accuracy of predicting the demand for hydrogen. That is, the timing when the client fills the vehicle with hydrogen often arrives substantially on the same cycle. Accordingly, the accuracy of prediction can be enhanced by adjusting the demand prediction model in such a manner as to predict that the demand increases at the timing corresponding to the cycle.

Besides, as exemplified in FIG. 5, the client behavioral pattern information includes the vehicle position. Accordingly, the demand prediction unit 142 predicts a demand for hydrogen through the use of the position of the vehicle of the client, which is indicated by the client behavioral pattern information. Besides, as exemplified in FIG. 5, the client behavioral pattern information includes the remaining amount of hydrogen. Accordingly, the demand prediction unit 142 predicts a demand for hydrogen through the use of the remaining amount of hydrogen in the vehicle 2 of the client, which is indicated by the client behavioral pattern information. The demand prediction unit 142 (the prediction unit 140) predicts the demand for hydrogen as described above, and hence can enhance the accuracy of predicting the demand for hydrogen. That is, the client is likely to visit a hydrogen station at a timing when, for example, the remaining amount of hydrogen in the vehicle 2 of the client becomes small enough to require the filling of the vehicle 2 with hydrogen (the filling rate of 20% in the examples of FIG. 6 and FIG. 8, and the filling rate of 40% in the examples of FIG. 7 and FIG. 9). Besides, the client is likely to visit a hydrogen station located close to the vehicle position at the timing. Accordingly, the accuracy of prediction can be enhanced by adjusting the demand prediction model in such a manner as to predict that the demand for the hydrogen station located close to the vehicle position at the timing increases at the timing.

Besides, as exemplified in FIG. 5, the client behavioral pattern information includes reservation information. Accordingly, the demand prediction unit 142 predicts a demand for hydrogen through the use of the reservation information from the client, which is indicated by the client behavioral pattern information. The demand prediction unit 142 (the prediction unit 140) predicts the demand for hydrogen as described above, and hence can enhance the accuracy of predicting the demand for hydrogen. That is, the client is very likely to visit a hydrogen station at a timing corresponding to the reservation information. Accordingly, the accuracy of prediction can be enhanced by adjusting the demand prediction model in such a manner as to predict that the demand increases at the timing.

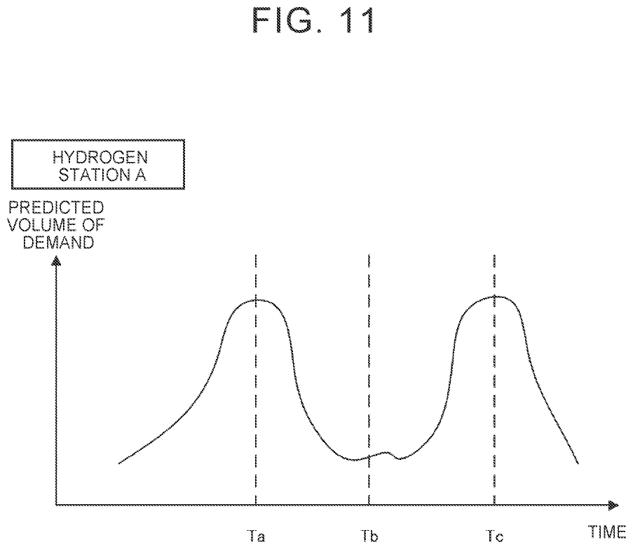

FIG. 11 is a view exemplifying a prediction of demand obtained by the demand prediction unit 142 according to the first embodiment. FIG. 11 exemplifies the prediction of demand at the hydrogen station A. Besides, FIG. 11 shows a graph with the axis of abscissa representing time and the axis of ordinate representing the predicted volume of demand. It should be noted herein that predicted volumes of demand at a plurality of timings (after T₁, after T₂, after T₃, after T₄, . . . ) are output from the demand prediction model, as exemplified in FIG. 10. Accordingly, the graph exemplified in FIG. 11 can be generated by plotting the predicted volumes of demand at these timings.

In the prediction of demand exemplified in FIG. 11, the demand increases at the timing corresponding to Ta. Besides, the demand decreases at the timing corresponding to Tb. Besides, the demand increases at the timing corresponding to Tc. Incidentally, Ta, Tb, and Tc may indicate times of day, periods of time, or dates. It can depend on which one of the timings is selected to predict the demand, whether or not each of the timings indicates a time of day, a period of time, or a date. For example, in the case where the demand prediction model is configured to predict a demand in each of the periods of time in a day, the aforementioned timings can indicate periods of time. Besides, in the case where the demand prediction model is configured to predict a demand on each of the days of a week or a month, the aforementioned timings can indicate dates.

The possible supply amount decision unit 144 decides amounts of suppliable hydrogen (possible amounts of supply) corresponding to timings, based on the predicted demands respectively. In concrete terms, the possible supply amount decision unit 144 decides the possible amount of supply in such a manner as to increase the possible amount of supply at a timing when the demand is predicted to be high. On the other hand, the possible supply amount decision unit 144 decides the possible amount of supply in such a manner as to reduce the possible amount of supply at a timing when the demand is predicted to be low. In the example of FIG. 11, the possible supply amount decision unit 144 decides the possible amount of supply at the respective timings such that the possible amount of supply at the timing Ta becomes larger than the possible amount of supply at the timing Tb, as to the hydrogen station A. By the same token, the possible supply amount decision unit 144 decides the possible amounts of supply at the respective timings such that the possible amount of supply at the timing Tc becomes larger than the possible amount of supply at the timing Tb, as to the hydrogen station A.

As described hitherto, the possible supply amount decision unit 144 (the prediction unit 140) decides the amounts of suppliable hydrogen (the possible amounts of supply) corresponding to the timings, based on the predicted demand, and can thereby stabilize the profit of the hydrogen station. That is, the number of missed opportunities such as the unavailability of hydrogen at the hydrogen station at the time when the client visits the hydrogen station with a view to filling the vehicle 2 with hydrogen can be reduced by increasing the possible amount of supply at a timing when the demand is predicted to be high. Besides, the number of losses resulting from excessive preparation can be reduced by reducing the possible amount of supply at a timing when the demand is predicted to be low. Accordingly, the profit of the hydrogen station can be stabilized.

Besides, the possible supply amount decision unit 144 may decide preparation amounts of hydrogen in accordance with timings when hydrogen is ordered, based on the predicted demands for hydrogen respectively. In concrete terms, the possible supply amount decision unit 144 decides the preparation amount of hydrogen corresponding to the demand in a period corresponding to the frequency with which hydrogen is ordered, as to each of the hydrogen stations. For example, in the case where hydrogen is ordered every week as to the hydrogen station A, the possible supply amount decision unit 144 decides the preparation amount of hydrogen corresponding to the predicted demand for hydrogen for a week, as to the hydrogen station A. For example, the preparation amount of hydrogen may be decided by summating predicted volumes of demand at the respective timings when the demands are predicted during a week. As described hitherto, the possible supply amount decision unit 144 (the prediction unit 140) decides the preparation amounts of hydrogen in accordance with the timings when hydrogen is ordered, based on the predicted demands for hydrogen respectively, and the aforementioned number of missed opportunities or cases of excessive preparation can thereby be further reduced.

Besides, the possible supply amount decision unit 144 may determine timings when high-pressure hydrogen gas is prepared, based on the predicted demands respectively. In concrete terms, in the case where the demands for hydrogen are predicted in periods of time during a day respectively, the possible supply amount decision unit 144 decides the timings when high-pressure gas is prepared, in such a manner as to prepare high-pressure gas (high-pressure hydrogen) earlier than the periods of time when the demand becomes high, by a predetermined time (e.g., one hour), respectively. Incidentally, “the predetermined time” can be set as appropriate in accordance with the time needed to raise the pressure of hydrogen. At each of the hydrogen stations, even when hydrogen is prepared, the vehicle 2 cannot be supplied with the hydrogen unless the pressure of the hydrogen is raised. Accordingly, the number of missed opportunities such as the unavailability of hydrogen to be supplied to the vehicle 2 at the time when the client visits the hydrogen station can be reduced, by deciding the timings when high-pressure hydrogen gas is prepared, based on the predicted demands, respectively.

The notification unit 150 notifies the client of the timings when the vehicle can be supplied with hydrogen and the hydrogen stations where the vehicle can be supplied with hydrogen, based on the predicted demands, respectively. The notification unit 150 transmits a notification (a notification of possible supply) indicating the hydrogen stations where the vehicle can be supplied with hydrogen and the timings (periods of time) when the vehicle can be supplied with hydrogen at the hydrogen stations respectively, to the device of the client via the network 1a, through the use of the interface unit 18.

In concrete terms, the notification unit 150 determines a timing when it is predicted that there is a demand for hydrogen, as to each of the hydrogen stations. For example, the notification unit 150 determines a timing when the volume of demand for hydrogen is equal to or higher than a value determined in advance, as to each of the hydrogen stations. The notification unit 150 then sets the timing when it is predicted that there is a demand for hydrogen as a timing when the vehicle can be supplied with hydrogen, as to each of the hydrogen stations. The notification unit 150 then generates a notification of possible supply, in accordance with this hydrogen station and this timing. The notification unit 150 transmits the generated notification of possible supply.

For example, the notification unit 150 may transmit the notification of possible supply to the vehicle 2 of the client. Thus, the notification of possible supply is displayed in the vehicle 2. In this case, the notification unit 150 may display the notification of possible supply through the use of a navigation system mounted in the vehicle 2. For example, in the case where a hydrogen station where the vehicle can be supplied with hydrogen is displayed on a screen of the navigation system, the notification unit 150 may display a timing when the vehicle can be supplied with hydrogen at the hydrogen station.

Besides, for example, the notification unit 150 may transmit the notification of possible supply to a terminal (a smartphone or the like) owned by the client. In this case, the notification unit 150 may perform a process similar to the process concerning the aforementioned navigation system of the vehicle 2, as to a navigation system that can be realized in the terminal of the client. Alternatively, the notification unit 150 may cause the terminal to display a list on which the hydrogen stations and the timings when the vehicle can be supplied with hydrogen are associated with each other respectively.

Alternatively, the notification unit 150 may cause a website about hydrogen stations to display the notification of possible supply. In this case, the notification unit 150 may cause the website to display a map, such that the timings when the vehicle can be supplied with hydrogen at the hydrogen stations displayed on the map respectively are displayed. Alternatively, the notification unit 150 may cause the website to display the list on which the hydrogen stations and the timings when the vehicle can be supplied with hydrogen are associated with each other respectively.

The notification unit 150 notifies the client of the timings when the vehicle can be supplied with hydrogen and the hydrogen stations where the vehicle can be supplied with hydrogen, in accordance with the predicted demands respectively, and the convenience for the client can thereby be enhanced. Furthermore, the possibility of the prepared hydrogen being supplied is further enhanced for the hydrogen station sides as well. Accordingly, the demand for hydrogen and the supply of hydrogen can be more reliably adjusted by notifying the client as described above.

Besides, the notification unit 150 may notify the client of the price of hydrogen as well, in notifying the client of the hydrogen stations where the vehicle can be supplied with hydrogen and the timings when the vehicle can be supplied with hydrogen. Thus, the client can simultaneously grasp the price of hydrogen and the timings when the vehicle 2 can be filled with hydrogen, so the convenience for the client is enhanced.

The learning continuation processing unit 160 performs a process for continuing to learn the demand prediction model. In concrete terms, the learning continuation processing unit 160 acquires an actual value corresponding to a predicted value of demand (an actual volume of demand). The learning continuation processing unit 160 then performs a continuation process of the learning by the learning unit 100 (a learning continuation process) in accordance with a difference between the predicted value of demand and the actual value. In more concrete terms, the learning continuation processing unit 160 performs the learning continuation process when the difference between the predicted value of demand and the actual value is equal to or larger than a threshold determined in advance. That is, the accuracy in predicting the demand by the demand prediction model may fall when the difference between the predicted value of demand and the actual value becomes large. Accordingly, it is preferable to relearn the demand prediction model in this case. Incidentally, the aforementioned threshold can be determined as appropriate in accordance with the required accuracy of demand.

The learning continuation process can be performed, for example, as follows. The learning continuation processing unit 160 acquires client behavioral pattern information (and regional information) to a time point when the difference between the predicted value of demand and the actual value becomes equal to or larger than the threshold determined in advance, as input data. Besides, the learning continuation processing unit 160 acquires an actual value of the demand obtained to that time point, as right answer data. It should be noted herein that since a certain time has elapsed at this time point from the stage of learning the demand prediction model, the data volume of input data acquired at this time point is larger than the data volume of input data used at the stage of learning the demand prediction model. The learning continuation processing unit 160 then performs the process in such a manner as to relearn the demand prediction model, using pairs of the acquired input data and the right answer data as teacher data. Thus, the learning unit 100 relearns the demand prediction model.

Incidentally, the learning continuation process may not necessarily be performed immediately at the time point when the difference between the predicted value of demand and the actual value becomes equal to or larger than the threshold. For example, the learning continuation process may be performed when the difference between the predicted value of demand and the actual value becomes equal to or larger than the threshold a predetermined number of times or more.

As described hitherto, the information processing device 10 may continue to learn the algorithm of mechanical learning, in accordance with the difference between the demand predicted by the prediction unit 140 and the actual demand. Owing to this configuration, the demand prediction model is adjusted in accordance with the actual operation, so the accuracy of predicting the demand can be further enhanced.

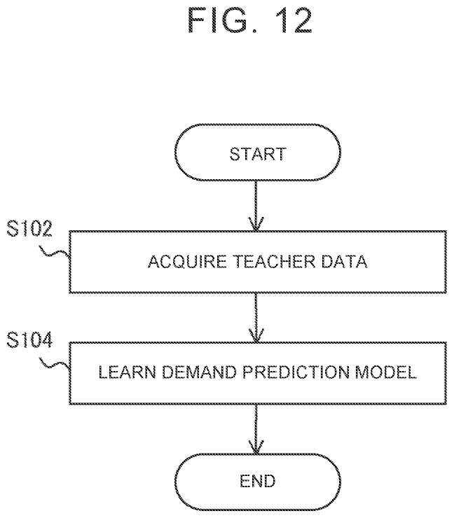

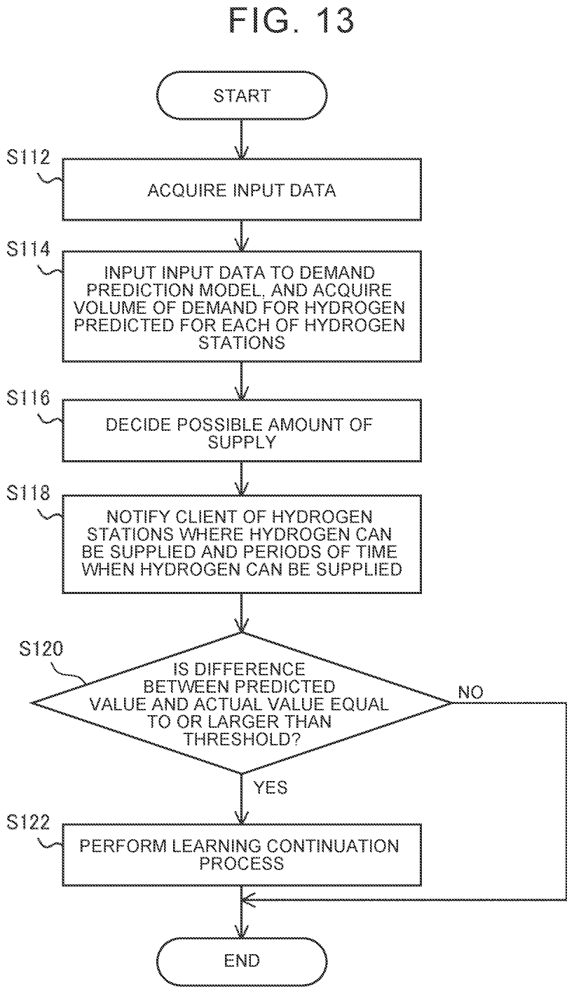

Each of FIG. 12 and FIG. 13 is a flowchart showing an information processing method that is carried out by the information processing device 10 according to the first embodiment. The flowchart shown in each of FIG. 12 and FIG. 13 corresponds to a demand prediction method for predicting a demand for hydrogen.

FIG. 12 shows a process at the stage of learning the demand prediction model. As described above, the teacher data acquisition unit 102 acquires teacher data as pairs of input data and right answer data (step S102). As described above, the demand prediction model learning unit 104 performs the process of learning the demand prediction model through the use of the acquired teacher data (step S104).

FIG. 13 shows a process at the stage of operating the demand prediction model. As described above, the input data acquisition unit 124 acquires input data (step S112). It should be noted herein that at least a client behavioral pattern (client behavioral pattern information) is included in the input data as described above.

As described above, the demand prediction unit 142 inputs the input data to the demand prediction model that is a learned model, and acquires a predicted volume of demand for hydrogen at each of the hydrogen stations (step S114). As described above, the possible supply amount decision unit 144 decides a possible amount of supply based on the predicted demand (step S116). As described above, the notification unit 150 notifies the client of hydrogen stations where the vehicle can be supplied with hydrogen and periods of time (timings) when the vehicle can be supplied with hydrogen (step S118).

The learning continuation processing unit 160 determines whether or not the difference between the predicted value of demand and an actual value is equal to or larger than the threshold determined in advance (step S120). If it is determined that the difference between the predicted value of demand and the actual value is equal to or larger than the threshold (YES in S120), the learning continuation processing unit 160 performs the learning continuation process as described above (step S122). On the other hand, if it is not determined that the difference between the predicted value of demand and the actual value is equal to or larger than the threshold (NO in S120), the processing of S122 is not performed. The processing of S112 to S122 can then be repeated.

### Second Embodiment

Next, the second embodiment will be described. The second embodiment is different from the first embodiment in that the business hours of each of the hydrogen stations are decided in accordance with the demand for hydrogen. Incidentally, the configuration of the information processing system 1 according to the second embodiment is substantially identical to the configuration of the information processing system 1 according to the first embodiment shown in FIG. 1, so the description thereof will be omitted. Besides, the hardware configuration of the information processing device 10 according to the second embodiment is substantially identical to the hardware configuration of the information processing device 10 according to the first embodiment shown in FIG. 2, so the description thereof will be omitted.

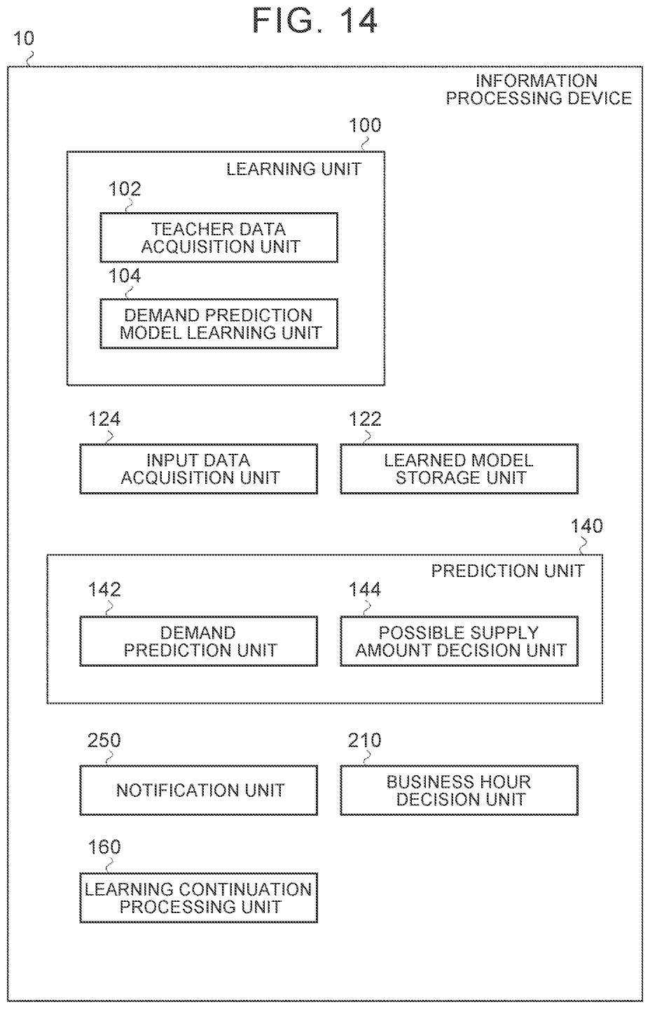

FIG. 14 is a block diagram showing the configuration of the information processing device 10 according to the second embodiment. The information processing device 10 according to the second embodiment has substantially the same components as those of the information processing device 10 according to the first embodiment shown in FIG. 3. Furthermore, the information processing device 10 according to the second embodiment has a business hour decision unit 210 (the decision unit) and a notification unit 250. In the information processing device 10 according to the second embodiment, the functions of the components of the information processing device 10 shown in FIG. 3 are substantially identical to those of the first embodiment unless otherwise specified, so the description thereof will be omitted as appropriate.

As described above, the prediction unit 140 predicts time-series demands for hydrogen at each of the hydrogen stations. That is, the prediction unit 140 predicts time-dependent changes in the demand for hydrogen at each of the hydrogen stations. Besides, the prediction unit 140 can predict at least time-dependent changes in the demand for hydrogen during one day after a time determined in advance (e.g., after one week or after one month) at each of the hydrogen stations.

The business hour decision unit 210 decides business hours based on the demand for hydrogen predicted by the prediction unit 140, as to each of the hydrogen stations. That is, the business hour decision unit 210 decides business hours in accordance with the predicted time-series volumes of demand for hydrogen, as to each of the hydrogen stations. In concrete terms, the business hour decision unit 210 decides the business hours of each of the hydrogen stations such that the hydrogen station operates in a period of time corresponding to the period of time when the volume of demand for hydrogen is high. Besides, the business hour decision unit 210 decides business hours after a time determined in advance (e.g., after one week or after one month) from the present.

In more concrete terms, the business hour decision unit 210 changes the business opening time to a time earlier than a usual business opening time of the hydrogen station when the demand predicted in a predetermined period including the usual business opening time is higher than a predetermined value. That is, the business hour decision unit 210 changes the business opening time to a time earlier than the usual business opening time of the hydrogen station when the demand predicted in a period of time close to the usual business opening time is higher than the predetermined value. The details will be described later. Owing to this configuration, the business opening time of the hydrogen station can be adjusted in accordance with the demand for hydrogen.

Besides, the business hour decision unit 210 changes the business closing time to a time later than a usual business closing time of the hydrogen station when the demand predicted in a predetermined period including the usual business closing time is higher than a predetermined value. That is, the business hour decision unit 210 changes the business closing time to a time later than the usual business closing time of the hydrogen station when the demand predicted in a period of time close to the usual business closing time is higher than the predetermined value. The details will be described later. Owing to this configuration, the business closing time of the hydrogen station can be adjusted in accordance with the demand for hydrogen.

Besides, the business hour decision unit 210 may change the business closing time to a time earlier than the usual business closing time of the hydrogen station when the demand predicted from the usual business closing time to a time point earlier than the usual business closing time by a predetermined period is lower than a predetermined value. That is, the business hour decision unit 210 may change the business closing time to a time earlier than the usual business closing time of the hydrogen station when the demand predicted in a period of time close to the usual business closing time is lower than the predetermined value. Owing to this configuration, the business closing time of the hydrogen station can be adjusted in accordance with the demand for hydrogen.

Besides, the business hour decision unit 210 may change the business opening time to a time later than the usual business opening time of the hydrogen station when the demand predicted from the usual business opening time to a time point later than the usual business opening time by a predetermined period is lower than a predetermined value. That is, the business hour decision unit 210 may change the business opening time to a time later than the usual business opening time when the demand predicted in a period of time close to the usual business opening time of the hydrogen station is lower than the predetermined value. The details will be described later. Owing to this configuration, the business opening time of the hydrogen station can be adjusted in accordance with the demand for hydrogen.

Incidentally, the process of making the business closing time earlier than the usual business closing time may be performed when the process of making the business opening time earlier than the usual business opening time is performed. By the same token, the process of making the business opening time later than the usual business opening time may be performed when the process of making the business closing time later than the usual business closing time is performed. Owing to this configuration, the business hours can be restrained from becoming too long as a result of making the business opening time of the hydrogen station earlier or making the business closing time of the hydrogen station later.

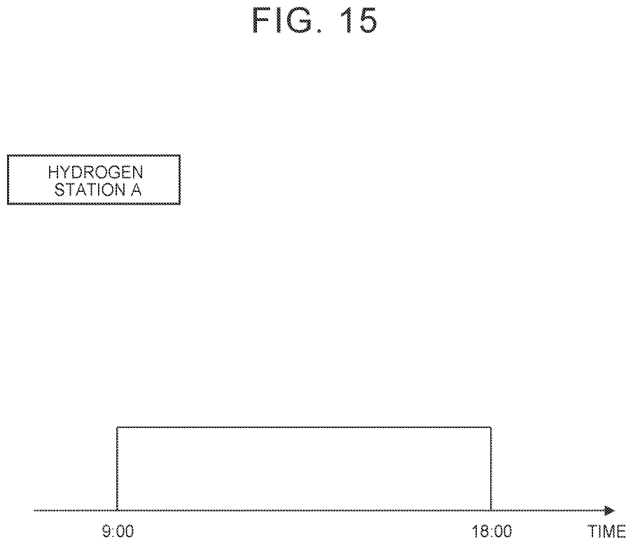

FIG. 15 is a view exemplifying the business hours of the hydrogen station. FIG. 15 is a view exemplifying the usual business hours (the original business hours) of the hydrogen station A. As exemplified in FIG. 15, the business is usually opened at nine o'clock and closed at 18 o'clock at the hydrogen station A. That is, the usual business opening time (the opening time) of the hydrogen station A is nine o'clock, and the usual business closing time (the closing time) of the hydrogen station A is 18 o'clock.

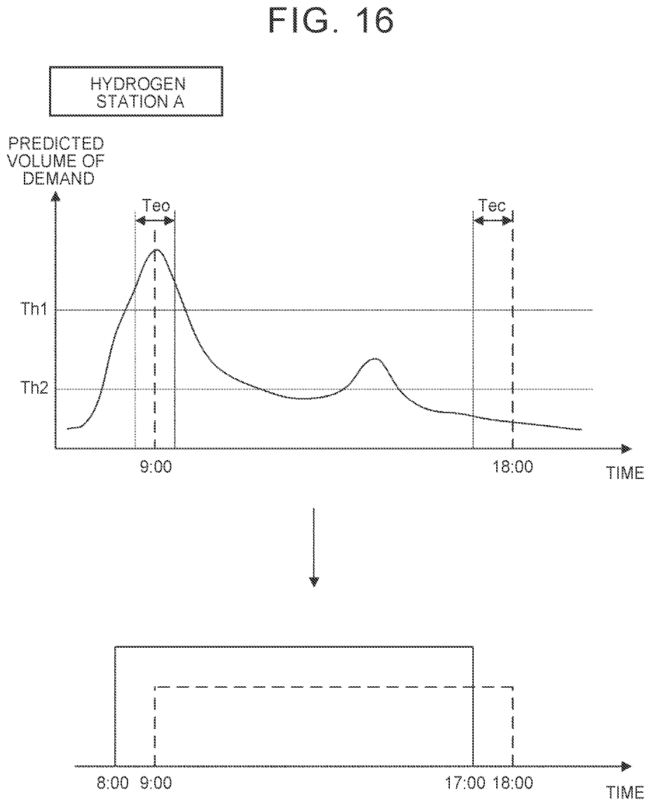

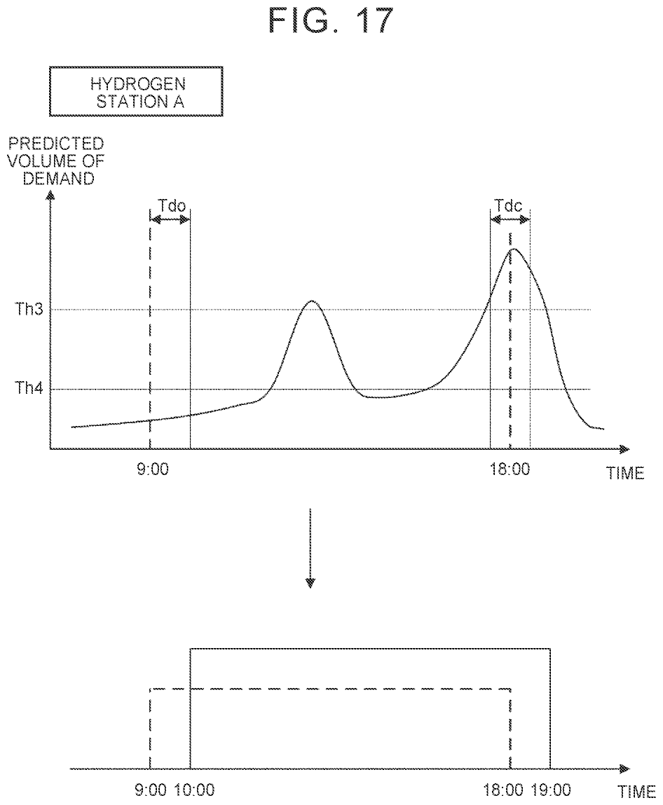

Each of FIG. 16 and FIG. 17 is a view for illustrating a method of deciding the business hours of the hydrogen station in the second embodiment. Each of FIG. 16 and FIG. 17 exemplifies how to change the business hours in accordance with the predicted demand for hydrogen with respect to the usual business hours of the hydrogen station A exemplified in FIG. 15, on a certain day after a time determined in advance (e.g., after one week or after one month) from the present. The upper view in each of FIG. 16 and FIG. 17 exemplifies time-dependent changes in the predicted volume of demand for hydrogen during one day. Besides, the lower view in each of FIG. 16 and FIG. 17 exemplifies the business hours changed in accordance with the predicted volume of demand for hydrogen.

In the example of FIG. 16, the demand is high around the usual business opening time. In concrete terms, the predicted volume of demand for hydrogen is higher than a threshold Th1 that is a predetermined value, during a predetermined period Teo including nine o'clock as the usual business opening time. In this case, the business hour decision unit 210 changes the business opening time to eight o'clock, which is earlier than the usual business opening time, as exemplified in the lower view of FIG. 16. That is, the business hour decision unit 210 changes the business opening time of the hydrogen station to a time earlier than the usual business opening time when the predicted volume of demand for hydrogen in the predetermined period Teo including the usual business opening time is higher than the threshold Th1. That is, the business hour decision unit 210 changes the business opening time to a time earlier than the usual business opening time of the hydrogen station when the predicted volume of demand for hydrogen is higher than the threshold Th1 at a time close to the usual business opening time.

It should be noted herein that the business hour decision unit 210 may change the business opening time to a time earlier than the usual business opening time when the predicted volume of demand for hydrogen is higher than the threshold Th1 in all the periods of time during the predetermined period Teo. Alternatively, the business hour decision unit 210 may change the business opening time to a time earlier than the usual business opening time when the predicted volume of demand for hydrogen is higher than the threshold Th1 in a period of time forming at least a part of the predetermined period Teo.

Incidentally, the threshold Th1 and the predetermined period Teo can be set as appropriate by, for example, an administrator of the hydrogen station (the hydrogen station A in the example of FIG. 16). Besides, the predetermined period Teo may be as long as, for example, five minutes, 10 minutes, 30 minutes, or one hour. Besides, the predetermined period Teo may be, for example, a period from a time point earlier than the usual business opening time by five minutes to a time point later than the usual business opening time by five minutes (i.e., Teo=10 minutes), or a period from a time point earlier than the usual business opening time by 30 minutes to a time point later than the usual business opening time by 30 minutes (i.e., Teo=one hour).

Besides, the predetermined period Teo may be, for example, a period from a time point earlier than the usual business opening time by three minutes to a time point later than the usual business opening time by seven minutes (i.e., Teo=10 minutes). Besides, the predetermined period Teo may be, for example, a period from a time point earlier than the usual business opening time by 10 minutes to a time point later than the usual business opening time by 20 minutes (i.e., Teo=30 minutes). Besides, the predetermined period Teo may be, for example, a period from a time point earlier than the usual business opening time by seven minutes to a time point later than the usual business opening time by three minutes (i.e., Teo=10 minutes). Besides, the predetermined period Teo may be, for example, a period from a time point earlier than the usual business opening time by 20 minutes to a time point later than the usual business opening time by 10 minutes (i.e., Teo=30 minutes).

Besides, the predetermined period Teo may be a period from the usual business opening time to a later time point. In this case, the predetermined period Teo may be, for example, a period from the usual business opening time to a time point later than the usual business opening time by 10 minutes (i.e., Teo=10 minutes), or a period from the usual business opening time to a time point later than the usual business opening time by one hour (i.e., Teo=one hour). Alternatively, the predetermined period Teo may be a period from an earlier time point to the usual business opening time. In this case, the predetermined period Teo may be, for example, a period from a time point earlier than the usual business opening time by 10 minutes to the usual business opening time (i.e., Teo=10 minutes), or a period from a time point earlier than the usual business opening time by one hour to the usual business opening time (i.e., Teo=one hour).

Incidentally, the predetermined period Teo may be changed as the process of predicting the demand for hydrogen advances. That is, the system is not operated at the stage of learning the demand prediction model, so the hydrogen station is likely to be out of operation before the usual business opening time. Accordingly, at this stage, it may be impossible to accurately predict the demand for hydrogen before the usual business opening time through the use of the demand prediction model. Accordingly, at the beginning of the operational stage, the predetermined period Teo may be a period from the usual business opening time to a later time point. On the other hand, it may become possible to accurately predict the demand before the usual business opening time, as the operation advances and as the learning of the demand prediction model advances. Accordingly, at the stage where the operation has advanced, the predetermined period Teo may be a period from an earlier time point to the usual business opening time, or a period stretching across the usual business opening time.

Besides, the length of time by which the business opening time is made earlier than the usual business opening time can also be set as appropriate by, for example, the administrator or the like of the hydrogen station (the hydrogen station A in the example of FIG. 16). For example, the business opening time may be made earlier than a time determined in advance. In this case, the business opening time may be made as early as possible insofar as the hydrogen station can be in operation, in consideration of the hours when employees can be on duty, and the like. Besides, in the case where, for example, the predetermined period Teo includes a period of time before the usual business opening time, the business opening time may be made as early as the beginning of the predetermined period Teo. Alternatively, at least the hydrogen station may be in operation in a period of time when, for example, the predicted volume of demand is higher than the threshold Th1 before the usual business opening time. In the example of FIG. 16, the business opening time may be made as early as a time point when the predicted volume of demand becomes higher than the threshold Th1 before the usual business opening time (nine o'clock).

Besides, in the example of FIG. 16, the demand is not high at a time close to the usual business closing time. In concrete terms, the predicted volume of demand for hydrogen is lower than a threshold Th2 that is a predetermined value from a time point earlier than the usual business closing time that is 18 o'clock by a predetermined period Tec to the usual business closing time. In this case, as exemplified in the lower view of FIG. 16, the business hour decision unit 210 may change the business closing time to 17 o'clock, which is earlier than the usual business closing time. That is, the business hour decision unit 210 may change the business closing time to a time earlier than the usual business closing time of the hydrogen station when the predicted volume of demand for hydrogen in the predetermined period Tec including the usual business closing time is lower than the threshold Th2. That is, the business hour decision unit 210 may change the business closing time to a time earlier than the usual business closing time of the hydrogen station when the predicted volume of demand for hydrogen is lower than the threshold Th2 at a time close to the usual business closing time. Incidentally, the business closing time may thus be made earlier than the usual business closing time in the case where the business opening time is made earlier. Thus, the business hours can be restrained from being prolonged as a result of making the business opening time earlier. Accordingly, the working hours of the employees can be restrained from increasing, so the cost of labor can be restrained from increasing.

Incidentally, the threshold Th2 and the predetermined period Tec can be set as appropriate by, for example, the administrator or the like of the hydrogen station (the hydrogen station A in the example of FIG. 16). Besides, the threshold Th2 may be any value equal to or smaller than Th1. Besides, Tec may be as long as, for example, five minutes, 10 minutes, 30 minutes, or one hour. Besides, the predetermined period Tec may be, for example, a period from a time point earlier than the usual business closing time by 10 minutes to the usual business closing time (i.e., Tec=10 minutes), or a period from a time point earlier than the usual business closing time by one hour to the usual business closing time (i.e., Tec=one hour). Incidentally, as is the case with Teo, the predetermined period Tec may be a period stretching across the usual business closing time.

In the example of FIG. 17, the demand is high at a time close to the usual business closing time. In concrete terms, the predicted volume of demand for hydrogen is higher than a threshold Th3 that is a predetermined value, during a predetermined period Tdc including 18 o'clock that is the usual business closing time. In this case, the business hour decision unit 210 changes the business closing time to 19 o'clock, which is later than the usual business closing time, as exemplified in FIG. 17. That is, the business hour decision unit 210 changes the business closing time to a time later than the usual business closing time when the predicted volume of demand for hydrogen in the predetermined period Tdc including the usual business closing time of the hydrogen station is higher than the threshold Th3. That is, the business hour decision unit 210 changes the business closing time to a time later than the usual business closing time when the predicted volume of demand for hydrogen is higher than the threshold Th3 at a time close to the usual business closing time of the hydrogen station.

It should be noted herein that the business hour decision unit 210 may change the business closing time to a time later than the usual business closing time when the predicted volume of demand for hydrogen is higher than the threshold Th3 in all the periods of time during the predetermined period Tdc. Alternatively, the business hour decision unit 210 may change the business closing time to a time later than the usual business closing time when the predicted volume of demand for hydrogen is higher than the threshold Th3 in a period of time forming at least a part of the predetermined period Tdc.

Incidentally, the threshold Th3 and the predetermined period Tdc can be set as appropriate by, for example, the administrator or the like of the hydrogen station (the hydrogen station A in the example of FIG. 17). The threshold Th3 may be the same as the threshold Th1. On the other hand, when the administrator or the like desires to make the business closing time later rather than making the business opening time earlier in accordance with the predicted volume of demand, Th3 may be smaller than Th1. On the contrary, when the administrator or the like desires to make the business opening time earlier rather than making the business closing time later in accordance with the predicted volume of demand, Th3 may be larger than Th1.

Besides, the predetermined period Tdc may be as long as, for example, five minutes, 10 minutes, 30 minutes, or one hour. Besides, the predetermined period Tdc may be, for example, a period from a time point earlier than the usual business closing time by five minutes to a time point later than the usual business closing time by five minutes (i.e., Tdc=10 minutes), or a period from a time point earlier than the usual business closing time by 30 minutes to a time point later than the usual business closing time by 30 minutes (i.e., Tdc=one hour).

Besides, the predetermined period Tdc may be, for example, a period from a time point earlier than the usual business closing time by seven minutes to a time point later than the usual business closing time by three minutes (i.e., Tdc=10 minutes). Besides, the predetermined period Tdc may be, for example, a period from a time point earlier than the usual business closing time by 20 minutes to a time point later than the usual business closing time by 10 minutes (i.e., Tdc=30 minutes). Besides, the predetermined period Tdc may be, for example, a period from a time point earlier than the usual business closing time by three minutes to a time point later than the usual business closing time by seven minutes (i.e., Tdc=10 minutes). Besides, the predetermined period Tdc may be, for example, a period from a time point earlier than the usual business closing time by 10 minutes to a time point later than the usual business closing time by 20 minutes (i.e., Tdc=30 minutes).

Besides, the predetermined period Tdc may be a period from an earlier time point to the usual business closing time. In this case, the predetermined period Tdc may be, for example, a period from a time point earlier than the usual business closing time by 10 minutes to the usual business closing time (i.e., Tdc=10 minutes), or a period from a time point earlier than the usual business closing time by one hour to the usual business closing time (i.e., Tdc=one hour). Alternatively, the predetermined period Tdc may be a period from the usual business closing time to a later time point. In this case, the predetermined period Tdc may be, for example, a period from the usual business closing time to a time point later than the usual business closing time by 10 minutes (i.e., Tdc=10 minutes), or a period from the usual business closing time to a time point later than the usual business closing time by one hour (i.e., Tdc=one hour).

Incidentally, the predetermined period Tdc may be changed as the process of predicting the demand for hydrogen advances. That is, at the stage of learning the demand prediction model, the system is not operated, so the hydrogen station is likely to be out of operation after the usual business closing time. Accordingly, at this stage, it may be impossible to accurately predict the demand for hydrogen after the usual business closing time through the use of the demand prediction model. Accordingly, at the beginning of the operational stage, the predetermined period Tdc may be a period from an earlier time point to the usual business closing time. On the other hand, as the operation advances and the learning of the demand prediction model advances, it may become possible to accurately predict the demand after the usual business closing time. Accordingly, at the stage where the operation has advanced, the predetermined period Tdc may be a period from the usual business closing time to a later time point, or a period stretching across the usual business closing time.

Besides, the length of time by which the business closing time is made later than the usual business closing time can also be set as appropriate by, for example, the administrator or the like of the hydrogen station (the hydrogen station A in the example of FIG. 17). For example, the business closing time may be made later by a time determined in advance. In this case, the business closing time may be made as late as possible insofar as the hydrogen station can be in operation, in consideration of the hours when the employees can be on duty and the like. Besides, in the case where, for example, the predetermined period Tdc includes a period of time later than the usual business closing time, the business closing time may be as late as the end of the predetermined period Tdc. Alternatively, at least the hydrogen station may be in operation in a period of time when, for example, the predicted volume of demand is higher than the threshold Th3 after the usual business closing time. In the example of FIG. 17, the business closing time may be made as late as a time point when the predicted volume of demand becomes lower than the threshold Th3 after the usual business closing time (18 o'clock).

Besides, in the example of FIG. 17, the demand is not high at a time close to the usual business opening time. In concrete terms, the predicted volume of demand for hydrogen is lower than a threshold Th4 that is a predetermined value, in a period from nine o'clock that is the usual business opening time to a time point later than nine o'clock by a predetermined period Tdo. In this case, the business hour decision unit 210 may change the business opening time to 10 o'clock that is later than the usual business opening time, as exemplified in the lower view of FIG. 17. That is, the business hour decision unit 210 may change the business opening time to a time later than the usual business opening time when the predicted volume of demand for hydrogen in the predetermined period Tdo including the usual business opening time of the hydrogen station is lower than the threshold Th4. That is, the business hour decision unit 210 may change the business opening time to a time later than the usual business opening time when the predicted volume of demand for hydrogen is lower than the threshold Th4 at a time close to the usual business opening time of the hydrogen station. Incidentally, the business opening time may thus be made later than the usual business opening time when the business closing time is made later. Thus, the business hours can be restrained from being prolonged as a result of making the business closing time later. Accordingly, the working hours of the employees can be restrained from increasing, so the cost of labor can be restrained from increasing.

Incidentally, the threshold Th4 and the predetermined period Tdo can be set as appropriate by, for example, the administrator or the like of the hydrogen station (the hydrogen station A in the example of FIG. 17). Besides, the threshold Th4 may be any value equal to or smaller than Th3. Besides, the threshold Th4 may be the same as the threshold Th2. On the other hand, when the administrator or the like desires to make the business opening time later rather than making the business closing time earlier in accordance with the predicted volume of demand, Th4 may be larger than Th2. On the contrary, when the administrator or the like desires to make the business closing time earlier rather than making the business opening time later in accordance with the predicted volume of demand, Th4 may be smaller than Th2.

Besides, Tdo may be as long as, for example, five minutes, 10 minutes, 30 minutes, or one hour. Besides, the predetermined period Tdo may be, for example, a period from the usual business opening time to a time later than the usual business opening time by 10 minutes (i.e., Tdo=10 minutes), or a period from the usual business opening time to a time later than the usual business opening time by one hour (i.e., Tdo=one hour). Incidentally, as is the case with Tdc, the predetermined period Tdo may be a period stretching across the usual business opening time.

As described hitherto, the information processing device 10 according to the second embodiment is configured to decide the business hours of the hydrogen station, based on the demand for hydrogen at the hydrogen station predicted through the use of the demand prediction model that receives at least the behavioral pattern of the client. Accordingly, the business hours matching the demand for hydrogen can be decided at the hydrogen station. Thus, the possibility of hydrogen being available for supply in accordance with the demand for hydrogen at the hydrogen station is enhanced. Accordingly, the information processing device 10 according to the second embodiment can maintain a balance between the demand for hydrogen and the supply of hydrogen at the hydrogen station. Besides, the possibility of the hydrogen station being in operation when the client wants to fill the vehicle 2 with hydrogen is thus enhanced, so the convenience for the client can be enhanced. Besides, on the hydrogen station as well, the number of missed opportunities such as the unavailability of hydrogen to be supplied at the time when the client wants to fill the vehicle 2 with hydrogen at the hydrogen station can be reduced. Furthermore, it is easy to adjust the dates and hours when the employees of the hydrogen station are scheduled to be on duty, so the unnecessary personnel expenses can be reduced.

Besides, the business hour decision unit 210 is configured to decide the business hours after a time determined in advance from the present. It should be noted herein that the time point “after the time determined in advance” can be set as appropriate in accordance with the timing when the prediction unit 140 predicts the demand. Besides, the time point “after the time determined in advance” can be set as appropriate in accordance with the time point by which the dates and hours (shift) when the employees at the hydrogen stations are scheduled to be on duty should be adjusted. For example, in the case where the dates and hours when the employees are scheduled to be on duty need to be adjusted at the latest three days in advance, the business hour decision unit 210 may decide the business hours after three or more days from the present. Owing to this configuration, it becomes much easier to adjust the dates and hours when the employees of the hydrogen station are scheduled to be on duty, so the convenience for the employees can be enhanced.

The notification unit 250 notifies the client of the business hours decided by the business hour decision unit 210. The notification unit 250 transmits a notification indicating the business hours of the hydrogen station (a business hour notification) to the device of the client via the network 1a, through the use of the interface unit 18.

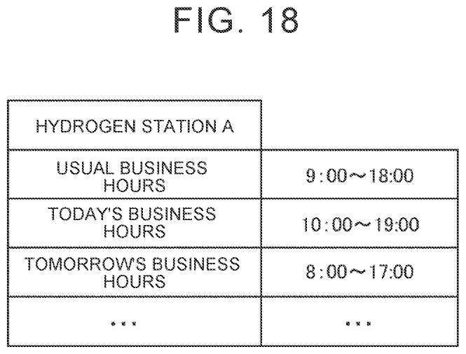

FIG. 18 is a view exemplifying the notification of the business hours according to the second embodiment. FIG. 18 exemplifies a business hour notification regarding the hydrogen station A. The business hour notification exemplified in FIG. 18 includes “the usual business hours”, “today's business hours”, and “tomorrow's business hours”. By being thus notified of the business hours for a plurality of dates, the client can decide the date on which he or she will visit the hydrogen station, in consideration of his or her schedule or the like. Accordingly, the convenience for the client can be enhanced.

Besides, the notification unit 150 may transmit the business hour notification to, for example, the vehicle 2 of the client. Thus, the business hour notification is displayed in the vehicle 2. In this case, the notification unit 250 may display the business hours through the use of the navigation system mounted in the vehicle 2. For example, the notification unit 250 may display the business hours of each of the hydrogen stations displayed on the screen of the navigation system.

Besides, for example, the notification unit 250 may transmit the business hour notification to a terminal (a smartphone or the like) owned by the client. In this case, the notification unit 250 may perform a process similar to the aforementioned process regarding the navigation system of the vehicle 2, as to a navigation system that can be realized by the terminal of the client.

Alternatively, the notification unit 250 may cause a website about hydrogen stations to display the business hour notification. In this case, the notification unit 250 may cause the website to display a map, such that the business hours of the hydrogen stations displayed on the map are displayed. Alternatively, the notification unit 250 may cause the website to display a list on which the hydrogen stations and the business hours are associated with each other respectively.

Besides, for example, the notification unit 250 may notify the client of the business hours of a hydrogen station that is frequently visited by the client. In this case, the notification unit 250 may determine the frequency with which the client visits the hydrogen station, through the use of the client behavioral pattern information. Besides, for example, the notification unit 250 may notify each of the clients of the business hours of a hydrogen station that is registered in advance by the client. For example, in the case where the client #1 has registered the hydrogen station A in the system, the notification unit 250 may notify the client #1 of the business hours of the hydrogen station A.

Besides, the notification unit 250 may notify each of the clients of the business hours at necessary timings. For example, when the business hours of a hydrogen station located near a client are changed, the notification unit 250 may notify the client of the business hours of the hydrogen station. Besides, for example, when the business hours of a hydrogen station registered in advance by a client are changed, the notification unit 250 may notify the client of the business hours of the hydrogen station. Besides, the notification unit 250 may notify a client driving the vehicle 2 in which a small amount of hydrogen remains, of the business hours of a hydrogen station.

The notification unit 250 notifies the client of the decided business hours, and the convenience for the client can thereby be enhanced. Furthermore, on the hydrogen station side as well, the possibility of prepared hydrogen being available for supply is enhanced. Accordingly, the demand for hydrogen and the supply of hydrogen can be more reliably adjusted, by notifying the client as described above. Besides, the notification unit 250 notifies each of the clients of the business hours at necessary timings, and the convenience for the clients can thereby be further enhanced.

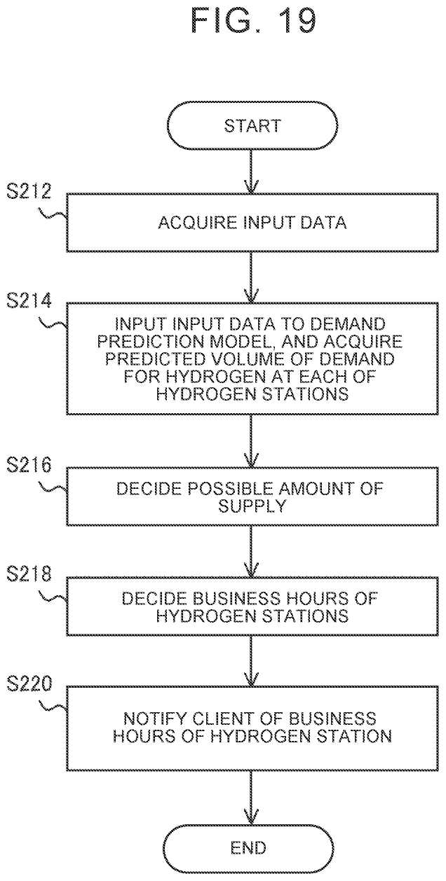

FIG. 19 is a flowchart showing an information processing method that is carried out by the information processing device 10 according to the second embodiment. The flowchart shown in FIG. 19 corresponds to a business hour decision method for deciding business hours of each of the hydrogen stations. As is the case with S112 of FIG. 13, the input data acquisition unit 124 acquires input data as described above (step S212). As is the case with S114 of FIG. 13, the demand prediction unit 142 inputs the input data to the demand prediction model that is a learned model, and acquires a predicted volume of demand for hydrogen at each of the hydrogen stations (step S214). As is the case with S114 of FIG. 13, the possible supply amount decision unit 144 decides a possible amount of supply based on the predicted demand (step S216).

As described above, the business hour decision unit 210 decides business hours of each of the hydrogen stations in accordance with the predicted demand for hydrogen (step S218). In concrete terms, the business hour decision unit 210 determines whether or not the demand predicted in a predetermined period including the usual business opening time of the hydrogen station is higher than a predetermined value (the threshold Th1). If the result of this determination is positive, the business hour decision unit 210 then changes the business opening time to a time earlier than the usual business opening time. Besides, the business hour decision unit 210 determines whether or not the demand predicted in a predetermined period including the usual business closing time of the hydrogen station is higher than a predetermined value (the threshold Th3). If the result of this determination is positive, the business hour decision unit 210 then changes the business closing time to a time later than the usual business closing time.

As described above, the notification unit 250 notifies the client of the business hours of the hydrogen station (step S220). Incidentally, the information processing device 10 according to the second embodiment may perform the learning continuation process (S122 of FIG. 13).

### Third Embodiment

Next, the third embodiment will be described. The third embodiment is different from the second embodiment in that the dates and hours when the employees can be on duty are taken into account in deciding the business hours of the hydrogen station. Incidentally, the configuration of the information processing system 1 according to the third embodiment is substantially identical to the configuration of the information processing system 1 according to the first embodiment shown in FIG. 1, so the description thereof will be omitted. Besides, the hardware configuration of the information processing device 10 according to the third embodiment is substantially identical to the hardware configuration of the information processing device 10 according to the first embodiment shown in FIG. 2, so the description thereof will be omitted.

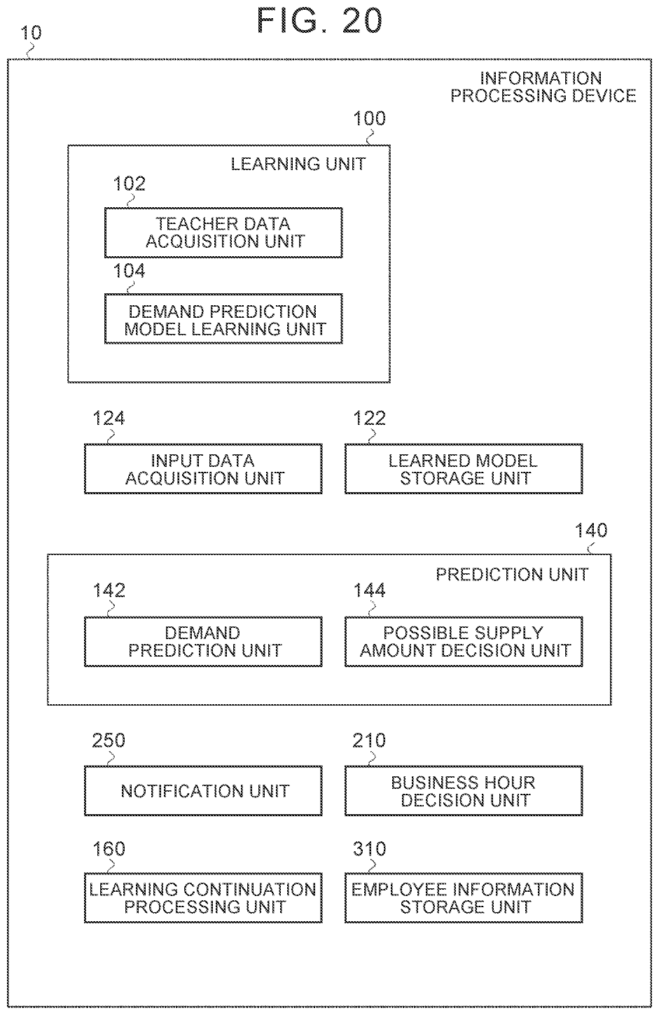

FIG. 20 is a block diagram showing the configuration of the information processing device 10 according to the third embodiment. The information processing device 10 according to the third embodiment has substantially the same components as those of the information processing device 10 according to the second embodiment shown in FIG. 14. Furthermore, the information processing device 10 according to the third embodiment has an employee information storage unit 310. In the information processing device 10 according to the third embodiment, the functions of the components of the information processing device 10 shown in FIG. 14 are substantially identical to those of the second embodiment unless otherwise specified, so the description thereof will be omitted as appropriate.

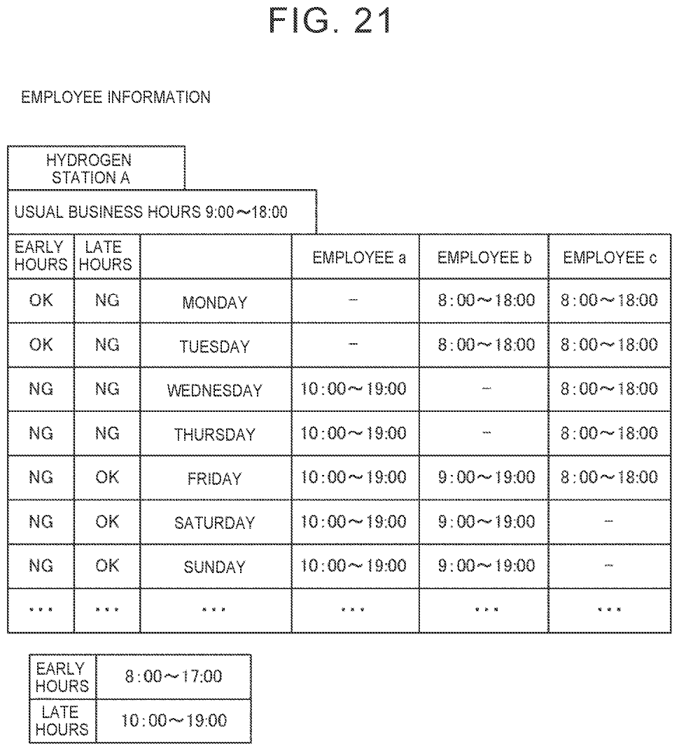

The employee information storage unit 310 stores employee information. The employee information indicates scheduled dates and hours when each of the employees of the hydrogen station can be on duty (the shift of each of the employees). Incidentally, the employee information will be described in detail using FIG. 21.

The business hour decision unit 210 decides business hours of the hydrogen station through the use of the employee information. That is, the business hour decision unit 210 decides the business hours of the hydrogen station, based on the dates and hours when the employees of the hydrogen station can be on duty. In concrete terms, the business hour decision unit 210 calculates (decides) the business hours of the hydrogen station in accordance with the predicted demand for hydrogen, as in the second embodiment. Then, when the calculated business hours are applicable in view of the dates and hours when the employees can be on duty, the business hour decision unit 210 decides the business hours of the hydrogen station as the calculated business hours. On the other hand, when the calculated business hours are not applicable in view of the dates and hours when the employees can be on duty, the business hour decision unit 210 does not change the business hours of the hydrogen station to the calculated business hours.

FIG. 21 is a view exemplifying the employee information according to the third embodiment. FIG. 21 exemplifies the employee information on the hydrogen station A during a certain week. In the example of FIG. 21, an employee a, an employee b, and an employee c work for the hydrogen station A. It is then assumed that at least two employees are needed to operate the hydrogen station A. In other words, the hydrogen station A cannot operate unless at least two employees are on duty. Incidentally, the number of employees required for operation can be set as appropriate for each of the hydrogen stations.

In the example of FIG. 21, the employee a can be on duty from 10 o'clock to 19 o'clock on Wednesday, Thursday, Friday, Saturday, and Sunday. Besides, the employee b can be on duty from eight o'clock to 18 o'clock on Monday and Tuesday and from nine o'clock to 19 o'clock on Friday, Saturday, and Sunday. Besides, the employee c can be on duty from eight o'clock to 18 o'clock on Monday through Friday.

In this case, the business hour decision unit 210 determines whether or not business hours (referred to as “early hours”) with the business opened earlier than the usual business opening time and closed earlier than the usual business closing time as exemplified in the lower view of FIG. 16 are applicable. Besides, the business hour decision unit 210 determines whether or not business hours (referred to as “late hours”) with the business opened later than the usual business opening time and closed later than the usual business closing time as exemplified in the lower view of FIG. 17 are applicable. That is, the business hour decision unit 210 calculates the business hours such as the early hours, the late hours or the like in accordance with the predicted demand, as in the second embodiment. The business hour decision unit 210 then determines whether or not the calculated business hours are applicable, through the use of the employee information.

On Monday, the employee b and the employee c are scheduled to be on duty. Besides, both the employee b and the employee c can be on duty from eight o'clock. Accordingly, since two or more employees can be on duty from eight o'clock on Monday, the business hour decision unit 210 determines that the business hours on Monday can be the early hours. Accordingly, when the business hours are calculated as the early hours in accordance with the demand for hydrogen as to Monday, the business hour decision unit 210 decides the business hours of the hydrogen station as the calculated business hours. Besides, both the employee b and the employee c can be on duty till 18 o'clock, but cannot be on duty till 19 o'clock. Accordingly, since two or more employees cannot be on duty till 19 o'clock on Monday, the business hour decision unit 210 determines that the business hours on Monday cannot be the late hours. Accordingly, even when the business hours are calculated as the late hours in accordance with the demand for hydrogen as to Monday, the business hour decision unit 210 does not change the business hours of the hydrogen station to the calculated business hours. The same as in the case of Monday holds true for Tuesday.

On Wednesday, the employee a and the employee c are scheduled to be on duty. Besides, the employee c can be on duty from eight o'clock, but the employee a cannot be on duty from eight o'clock. Accordingly, since two or more employees cannot be on duty from eight o'clock on Wednesday, the business hour decision unit 210 determines that the business hours on Wednesday cannot be the early hours. Accordingly, even when the business hours are calculated as the early hours in accordance with the demand for hydrogen as to Wednesday, the business hour decision unit 210 does not change the business hours of the hydrogen station to the calculated business hours. Besides, the employee a can be on duty till 19 o'clock, but the employee c cannot be on duty till 19 o'clock. Accordingly, since two or more employees cannot be on duty till 19 o'clock on Wednesday, the business hour decision unit 210 determines that the business hours on Wednesday cannot be the late hours. Accordingly, even when the business hours are calculated as the late hours in accordance with the demand for hydrogen as to Wednesday, the business hour decision unit 210 does not change the business hours of the hydrogen station to the calculated business hours. Incidentally, the same as in the case of Wednesday holds true for Thursday.

On Friday, the employee a, the employee b, and the employee c are scheduled to be on duty. Besides, the employee c can be on duty from eight o'clock, but the employee a and the employee b cannot be on duty from eight o'clock. Accordingly, since two or more employees cannot be on duty from eight o'clock on Friday, the business hour decision unit 210 determines that the business hours on Friday cannot be the early hours. Accordingly, even when the business hours are calculated as the early hours in accordance with the demand for hydrogen as to Friday, the business hour decision unit 210 does not change the business hours of the hydrogen station to the calculated business hours. Besides, the employee a and the employee b can be on duty till 19 o'clock. Accordingly, since two or more employees can be on duty till 19 o'clock on Friday, the business hour decision unit 210 determines that the business hours on Friday can be the late hours. Accordingly, when the business hours are calculated as the late hours in accordance with the demand for hydrogen as to Friday, the business hour decision unit 210 decides the business hours of the hydrogen station as the calculated business hours.

On Saturday, the employee a and the employee b are scheduled to be on duty. Besides, the employee a and the employee b cannot be on duty from eight o'clock. Accordingly, since two or more employees cannot be on duty from eight o'clock on Saturday, the business hour decision unit 210 determines that the business hours on Saturday cannot be the early hours. Accordingly, even when the business hours are calculated as the early hours in accordance with the demand for hydrogen as to Saturday, the business hour decision unit 210 does not change the business hours of the hydrogen station to the calculated business hours. Besides, the employee a and the employee b can be on duty till 19 o'clock. Accordingly, since two or more employees can be on duty till 19 o'clock on Saturday, the business hour decision unit 210 determines that the business hours on Saturday can be the late hours. Accordingly, when the business hours are calculated as the late hours in accordance with the demand for hydrogen as to Saturday, the business hour decision unit 210 decides the business hours of the hydrogen station as the calculated business hours. Incidentally, the same as in the case of Saturday holds true for Sunday.

As described hitherto, the business hour decision unit 210 according to the third embodiment is configured to decide the business hours of the hydrogen station, based on the dates and hours when the employees of the hydrogen station can be on duty. Accordingly, the business hours of the hydrogen station are decided in accordance with the dates and hours when the employees can be on duty, so the convenience for the employees can be enhanced. That is, the hydrogen station can be restrained from being operated when the employees cannot be on duty.

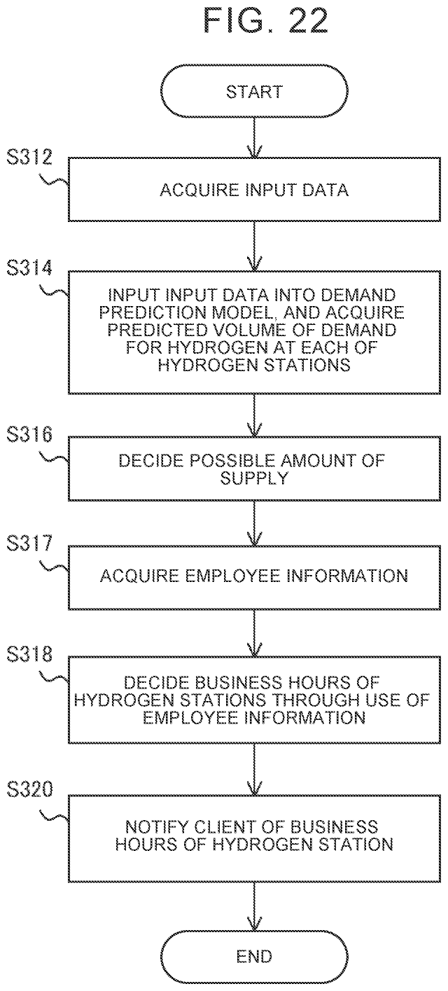

FIG. 22 is a flowchart showing an information processing method that is carried out by the information processing device 10 according to the third embodiment. The flowchart shown in FIG. 22 corresponds to a business hour decision method for deciding business hours of each of the hydrogen stations. As is the case with S112 of FIG. 13 and the like, the input data acquisition unit 124 acquires input data as described above (step S312). As is the case with S114 of FIG. 13 and the like, the demand prediction unit 142 inputs the input data to the demand prediction model that is a learned model, and acquires a predicted volume of demand for hydrogen for each of the hydrogen stations (step S314). As is the case with S114 of FIG. 13 and the like, the possible supply amount decision unit 144 decides a possible amount of supply based on the predicted demand (step S316).

The business hour decision unit 210 acquires employee information from the employee information storage unit 310 (step S317). The business hour decision unit 210 decides business hours of each of the hydrogen stations, through the use of the employee information (step S318). That is, the business hour decision unit 210 decides the business hours in accordance with the predicted demand for hydrogen and the number of employees who can be on duty. In concrete terms, the business hour decision unit 210 calculates the business hours of the hydrogen station in accordance with the predicted demand for hydrogen, as in the processing of S218 of FIG. 19. The business hour decision unit 210 then determines whether or not a required number of employees can be on duty during the calculated business hours, through the use of the employee information. If the result of this determination is positive, the business hour decision unit 210 then decides the business hours of the hydrogen station as the calculated business hours. On the other hand, if the result of this determination is not positive, the business hour decision unit 210 does not change the business hours of the hydrogen station to the calculated business hours.

As described above, the notification unit 250 notifies the client of the business hours of the hydrogen station (step S320). Incidentally, the information processing device 10 according to the third embodiment may perform the learning continuation process (S122 of FIG. 13).

### Modification Examples

Incidentally, the disclosure is not limited to the aforementioned embodiments, but can be altered as appropriate within such a range as not to depart from the gist thereof. For example, the sequence of the steps in each of the aforementioned flowcharts can be altered as appropriate. Besides, one or more of the steps in each of the aforementioned flowcharts can be omitted as appropriate. For example, the processing of S216 and S220 of FIG. 19 may be omitted. The same holds true for FIG. 22.

The program includes a group of commands (or software codes) for causing the computer to perform one or more of the functions described in the embodiments when the computer reads the program. The program may be stored in anon-temporary computer-readable medium or a tangible storage medium. Non-restrictive examples of the computer-readable medium or the tangible storage medium include a random-access memory (RAM), a read-only memory (ROM), a flash memory, a solid-state drive (SSD) or other memory technologies, a CD-ROM, a digital versatile disk (DVD), a Blu-ray (®) disk or other optical disk storages, a magnetic cassette, a magnetic tape, and a magnetic disk storage or other magnetic storage devices. The program may be transmitted via a temporary computer-readable medium or a communication medium. Non-restrictive examples of the temporary computer-readable medium or the communication medium include electric, optical, acoustic, or other propagated signals.

What is claimed is:

1. An information processing device comprising:
a prediction unit that predicts a demand for hydrogen at a hydrogen station, through use of a demand prediction model that is a learned model generated in advance through mechanical learning and that receives at least a behavioral pattern of a client and outputs the predicted demand for hydrogen; and
a decision unit that decides business hours of the hydrogen station, based on the predicted demand for hydrogen.

2. The information processing device according to claim 1, wherein
the decision unit changes a business opening time to a time earlier than a usual business opening time of the hydrogen station when the predicted demand in a predetermined period including the usual business opening time is higher than a predetermined value.

3. The information processing device according to claim 1, wherein
the decision unit changes a business closing time to a time later than a usual business closing time of the hydrogen station when the predicted demand in a predetermined period including the usual business closing time is higher than a predetermined value.

4. The information processing device according to claim 1, wherein
the decision unit decides business hours after a time determined in advance.

5. The information processing device according to claim 1, wherein
the decision unit decides business hours of the hydrogen station, based on dates and hours when an employee of the hydrogen station is ready to be on duty.

6. The information processing device according to claim 1, further comprising:
a notification unit that notifies the client of the decided business hours.

7. The information processing device according to claim 6, wherein
the notification unit notifies each client of business hours at a required timing.

8. An information processing method for predicting a demand for hydrogen at a hydrogen station through use of a demand prediction model that is a learned model generated in advance through mechanical learning and that receives at least a behavioral pattern of a client and outputs the predicted demand for hydrogen, and deciding business hours of the hydrogen station based on the predicted demand for hydrogen.

9. A non-transitory storage medium storing a program that causes a computer to execute a step of predicting a demand for hydrogen at a hydrogen station through use of a demand prediction model that is a learned model generated in advance through mechanical learning and that receives at least a behavioral pattern of a client and outputs the predicted demand for hydrogen, and a step of deciding business hours of the hydrogen station based on the predicted demand for hydrogen.
